(19) United States
(12) Patent Application Publication
(10) Pub. No.: US 2024/0066497 A1
(43) Pub. Date: Feb. 29, 2024

(54) NANOPOROUS SPONGES FOR WATER ADSORPTION, PROCESS FOR PREPARING THE SAME AND USES THEREOF

(71) Applicant: POLYVALOR, LIMITED PARTNERSHIP, QUÉBEC (CA)

(72) Inventors: Ulrich LEGRAND, Verdun (CA); Jason Robert TAVARES, Longueuil (CA); Richard BOUDREAULT, Saint-Laurent (CA)

(73) Assignee: POLYVALOR, LIMITED PARTNERSHIP, QUÉBEC, QC (CA)

(21) Appl. No.: 18/278,902

(22) PCT Filed: Feb. 28, 2022
(86) PCT No.: PCT/CA2022/050279

§ 371 Date: Aug. 25, 2023

Related U.S. Application Data
(60) Provisional application No. 63/154,663, filed on Feb. 26, 2021.

(51) Int. Cl. B01J 20/20; B01D 53/26; B01D 53/28; B01J 20/28; B01J 20/30; B01J 20/32

(52) U.S. Cl. CPC B01J 20/20; B01D 53/261; B01D 53/28; B01J 20/28061; B01J 20/28064; B01J 20/28071; B01J 20/28073; B01J 20/2808; B01J 20/28083; B01J 20/3078; B01J 20/3204; B01J 20/3255; B01D 2253/102; B01D 2257/80

(57) ABSTRACT

The present application relates to nanopourous material. More specifically, the present application relates to nanoporous carbonaceous material for water adsorption, process for their preparation and uses thereof. The present application includes a nanoporous carbonaceous material comprising at least one pyrolyzed an organic compound-formaldehyde resin, which may be further functionalized.

### CROSS-REFERENCE TO RELATED APPLICATION

The present application claims priority to U.S. Provisional Patent Application No. 63/154,663, which was filed Feb. 26, 2021, the contents of which are incorporated herein by reference in their entirety.

### FIELD

The present application is in the field of nanoporous material. More specifically, the present application relates to nanoporous carbonaceous material for water adsorption, process for their preparation and uses thereof.

### BACKGROUND

Large populations living in parts of the world depend either on water supplied by tankers, which is expensive and intermittent, or groundwater, which is not always suitable for drinking and not always replenished by surface water. A recent UN Water Crisis Report prepared by the Food and Agriculture Organization [1] shows that there is a growing global water crisis and that more than 2 billion people living in arid regions could be threatened by a water shortage.

Because an adequate supply of clean drinking water is a basic necessity for human survival, solutions to this growing crisis are required to avoid the worst. Various methods exist to generate fresh water, and most focus on using abundant seawater. Water desalination [2] is the process of removing salts and minerals from water to render it drinkable through thermal methods (multi flash distillation, multi effect distillation) or filtration methods (electrodialysis, reverse osmosis). Today, the leading process for intensive production of freshwater is reverse osmosis (RO) [3], which has become more cost effective in the past decade. However, RO requires the availability of energy (between 17 and 83 kWh per m³ [5]) together with large bodies of saline water, a distribution infrastructure and high upfront capital cost. On the other hand, water generation from humid air corresponds to typical dehumidification devices and require high energy intake to cool down humid air below dew point, from 270 to 550 kWh per cubic meter of captured water [5].

Typical water generation from humid air corresponds to typical dehumidification devices and requires energy to cool down humid air below the dew point (FIG. 1, thermodynamic approach [4]). The challenge here is to generate materials on which the humidity adsorption is made to occur with no cooling below ambient temperature to limit energy requirements. Following this adsorption, there is a need to desorb the captured water with minimal energy requirement (FIG. 1, sorption approach [5]). These nanostructured adsorbents are specifically designed to efficiently adsorb and desorb water from humidity using capillary condensation. In other words, the idea lies in the creation of a very efficient adsorbent based on nanostructure that would require a minimal energy input.

Another method that does not rely on saline water sources is fog harvesting (FIG. 1). In regions where precipitation is low or lacking, especially in remote areas such as mountains and islands in the dry season, it is feasible to set up a passive mesh system (mounted on a sturdy frame) to collect fresh water already condensed in the form of fog from the air. The mesh, which can be made from different materials, is exposed to foggy air masses, and this water-charged air is pushed through the mesh by wind currents [6]. Fog micro-droplets coalesce on the mesh to form larger drops that flow down the mesh through gravity drainage into gutters connected to a storage tank.

The adsorption and desorption in porous materials for atmospheric water harvesting relies on the principle of capillary condensation. Capillary condensation is a gas to liquid phase transition of an adsorbate in a porous material and under certain conditions. Capillary condensation happens at a vapor pressure lower than the saturation pressure (i.e. dew point). Suitable conditions include the type of adsorbate and porous material, the pore diameter and pore size distribution, and the gas temperature [7].

At low vapor pressure (i.e. low relative humidity) the gas first forms a monolayer of molecules adsorbed on the inner surface of the pores, followed by the growth of a metastable multilayer. The instability of the adsorbed multilayer results from a competition between the potential energy of adsorption of the substrate with the surface energy of the film and the capillary evaporation occurring simultaneously. At a critical thickness, liquid bridges can grow and form menisci whose curvature is dependent on the equilibrium vapor pressure and the surface tension of the liquid phase [8].

An important phenomenon in capillary condensation is the irreversibility between the adsorption and desorption phase, under the form of a hysteresis on the adsorption isotherms. The exact cause of this hysteresis is still debated, although several hypotheses are evoked, such as pore blocking, cavitation, irregularities in pore shape, inhomogeneity of surface chemistry or mechanical deformation of pores during condensation [9]. Hysteresis is undesirable since it prevents adsorbed water from leaving the adsorbent without addition of energy.

Hysteresis can be prevented by selecting pore diameters smaller than the critical pore diameter, and a temperature above the critical temperature. These critical values are specific to the gaseous phase studied and are equal to 3.0 nm for argon at 77 K and 2.1 nm for water at 298 K (room temperature) [7]. The pore size distribution also influences the shape of the hysteresis. Recent experiments have shown that a narrow pore size distribution is favorable to obtain a smaller hysteresis compared to a wide distribution.

Current research on harvesting humidity based on capillary condensation focuses on Metal Organic Frameworks (MOFs). MOFs are highly porous materials based on the coordination network of metal ions coordinated to organic ligands. The porosity is controlled via the nature of the metal ions and organic ligands as well as the synthesis parameters. MOFs are synthesized through solvothermal processes, where crystals grow slowly from hot solutions over the course of hours to days. The process is difficult to scale up and ongoing research is done to accelerate the crystal growth

with microwave radiation [10]. Because MOFs are made of coordinated ions, they can be affected by the presence of water. An important parameter to consider MOFs for water capture application is their hydrolytic stability, i.e. the material degradation in presence of water [11]. It is common to observe decrease of the performance over cycles of adsorption/desorption [11]. Some studies show MOFs with enhanced hydrolytic stability and thus better cyclability [12]. With their highly controlled porosity MOFs can have water uptakes of more than 1 kg/kg of material at high relative humidity (FIG. 2) [11]. Some studies tend to go towards carbonaceous materials as adsorbent in order to overcome stability issues, lifetime and difficulty to scale up [13].

Similarly, to the MOF structure, covalent-organic frameworks (COFs) are also investigated as water adsorbents [14]. Contrary to MOFs, whose networks are coordinated by metallic ions, COFs are covalently bonded by light elements (B, C, Si, N and O) that improve their stability in contact of water.

A recent study also presented a new absorbent material, the super moisture-absorbent gel (SMAG) [15]. Composed of hygroscopic polypyrrole chloride in hydrophilicity-switchable polymer made of poly N-isopropylacrylamide, the SMAG shows outstanding water uptake up to 6 g/g of material with low energy requirements for water release. No information on cyclability is available for such material.

Sorbent materials, either in the form of MOF or COF, need a particular device that allows adsorption from humid air and then release it under the form of liquid water with minimal energy input. A typical set-up based on day and night cycles is shown on FIG. 3 [16], from US20180171604A1, claiming several forms of heating for the desorption, such as solar irradiance, heat from the combustion of waste or biomass, a condenser with a heat sink and adsorbent materials comprising zeolites, MOF, silica gel, carbon fibers or hydroscopic salts.

However, MOF adsorbents are difficult and costly to synthesize. For example, MOF-801, a common material studied in water harvesting, requires zirconium metal at the cost of 200 CAD $/kg (Zr makes up approximately 40% of the MOF-801 mass), without counting the price of the organic compounds and processing steps [17]. Moreover, some MOF-based water harvesting systems reported in the literature suffer from scalability issues and performance stability [13]. Indeed, the amount of water collected with MOF can decrease after only 5 cycles of adsorption/desorption [11].

Moreover, current technologies involving thermodynamic cycles have a low coefficient of performance (COP) due to the use of refrigeration dehumidification process which cools the air below dew point to condense water vapour under the form of humidity. Subsequent reheating of the dry air consumes considerable amounts of energy.

There is a need for adsorbent material that can be easily scaled up, preferably using cheap and abundant chemicals, that can be produced using a minimal amount of energy, while maintaining good water uptake and kinetics sustainably.

Accordingly, there is a need for a material that would overcome at least one drawback of current technologies.

### SUMMARY

It has been surprisingly shown herein that nanoporous carbonaceous material of the present application provide highly stable water adsorbent material at a low cost, requiring minimal energy to prepare and to operate. The nanoporous carbonaceous material of the present application provides for sustainably good water uptake and fast adsorption kinetics. Comparable materials and processes did not display the same properties, highlighting the surprising results obtained with the materials and processes of the application.

Accordingly, the present application includes a nanoporous carbonaceous material comprising an elemental content, in wt % based on total weight of the material, in carbon of about 85% to about 99.5%, oxygen of about 0.5% to about 10%, and nitrogen of about 0% to about 5%, and wherein the material is optionally functionalized.

The present application further includes a nanoporous carbonaceous material for use in water adsorption, the material comprising an elemental content, in wt % based on total weight of the material, in carbon of about 85% to about 99.5%, oxygen of about 0.5% to about 10%, and nitrogen of about 0% to about 5%, and wherein the material is optionally functionalized.

The present application also includes a nanoporous carbonaceous material comprising at least one pyrolyzed organic compound-formaldehyde resin, wherein the organic compound is selected from resorcinol, urea, melamine, a tannin and combinations thereof and wherein the material is optionally functionalized.

The present application further provides a nanoporous carbonaceous material for use in water adsorption, the material comprising at least one pyrolyzed organic compound-formaldehyde resin, wherein the organic compound is selected from resorcinol, urea, melamine, a tannin and combinations thereof and wherein the material is optionally functionalized.

The present application also includes a nanoporous carbonaceous material comprising at least one pyrolyzed organic compound-formaldehyde resin, wherein the organic compound is any organic compound and wherein the material is optionally functionalized.

The present application further provides a nanoporous carbonaceous material for use in water adsorption, the material comprising at least one pyrolyzed organic compound-formaldehyde resin, wherein the organic compound is any organic compound and wherein the material is optionally functionalized.

In some embodiments, the nanoporous carbonaceous material has an average pore size of about 1 to about 10 nm. In some embodiments, the average pore size is about 1.5 nm.

In some embodiments, the nanoporous carbonaceous material has a pore size distribution is about 1.3 to about 1.9 nm.

In some embodiments, the nanoporous carbonaceous material has a specific surface area of about 300 m²/g to about 550 m²/g. In some embodiments, the specific surface area is about 350 m²/g to about 525 m²/g.

In some embodiments, the nanoporous carbonaceous material has an average pore volume of about 0.20 cm³/g to about 0.50 cm³/g. In some embodiments, the average pore volume is about 0.23 cm³/g to about 0.35 cm³/g.

In some embodiments, the nanoporous carbonaceous material is functionalized with at least one functional group selected from hydroxyl, carbonyl, carboxyl, amino, sulfhydryl, and phosphate groups. In some embodiments, the nanoporous carbonaceous material is functionalized with at least one of nitrogen-based moieties, oxygen-based moieties, sulfur-based moieties, phosphor-based moieties, metal-based moieties or mixtures thereof. In some embodiments, the at least one of nitrogen-based moieties, oxygen-based moieties, sulfur-based moieties, phosphor-based moieties, metal-based moieties or mixtures thereof are added prior and/or after pyrolysis in an amount from about 10% to about 50% (wt) based on total material. In some embodiments, the at least one of nitrogen-based moieties, oxygen-based moieties, sulfur-based moieties, phosphor-based moieties, metal-based moieties or mixtures thereof are added prior and/or after in an amount of about 40% (wt) based on total material.

In some embodiments, the nitrogen-based moieties is from a heterocyclic organic compound selected from phenathroline, pyridine, pyrrolidine, and pyrrole.

In some embodiments, the oxygen-based moieties is from air, pure oxygen, hydrogen peroxide, ozone, carbon dioxide, carbon monoxide or a mixture of O₂/N₂.

In some embodiments, the nanoporous carbonaceous material is selected from a nitrogen functionalized material, an oxygen functionalized material, or a nitrogen-oxygen functionalized material.

In some embodiments, the nanoporous carbonaceous material has an elemental content, in wt % based on total weight of the material, in carbon of about 86% to about 99%, oxygen of about 0.8% to about 9.5%, and nitrogen of about 0% to about 4.5%.

In some embodiments, the nanoporous carbonaceous material has a surface concentration, in wt % based on total weight of the material, in carbon of about 87% to about 95%, oxygen of about 4% to about 8% and nitrogen of about 0% to about 5%. In some embodiments, the nanoporous carbonaceous material has a surface concentration, in wt % based on total weight of the material, in carbon of about 88% to about 94%, oxygen of about 5% to about 8% and nitrogen of about 0% to about 4.5%.

In some embodiments, the nitrogen functionalized material has an elemental content, in wt % based on total weight of the material, in carbon of from about 95% to about 97%, oxygen of about 0.5% to about 1.5% and nitrogen of about 2% to about 3%.

In some embodiments, the oxygen functionalized material has an elemental content, in wt % based on total weight of the material, in carbon of from about 97% to about 98%, oxygen of about 2% to about 2.5% and nitrogen of about 0% to about 0.5%.

In some embodiments, the nitrogen-oxygen functionalized material has an elemental content, in wt % based on total weight of the material, in carbon of from about 85% to about 87%, oxygen of about 9% to about 10% and nitrogen of about 3% to about 5%.

In some embodiments, the nitrogen functionalized material has a surface concentration, in wt % based on total weight of the material, in carbon of about 90% to about 94%, oxygen of about 3% to about 6% and nitrogen of about 0.5% to about 4%.

In some embodiments, the oxygen functionalized material has a surface concentration, in wt % based on total weight of the material, in carbon of about 92% to about 94%, oxygen of about 6% to about 8% and nitrogen of about 0% to about 0.5%.

In some embodiments, the nitrogen-oxygen functionalized material has a surface concentration, in wt % based on total weight of the material, in carbon of about 87% to about 89%, oxygen of about 6% to about 8% and nitrogen of about 3% to about 5%.

In some embodiments, the nanoporous carbonaceous material has a water adsorption uptake of about 0.1 kg_{water}/kgₘₐₜₑᵣᵢₐₗ to about 0.2 kg_{water}/kgₘₐₜₑᵣᵢₐₗ at 40% of relative humidity. In some embodiments, the nanoporous carbonaceous material has a water adsorption uptake of about 0.1 kg_{water}/kgₘₐₜₑᵣᵢₐₗ to about 0.5 kg_{water}/kgₘₐₜₑᵣᵢₐₗ at 90% of relative humidity. In some embodiments, the nanoporous carbonaceous material has a water adsorption uptake of about 0.1 kg_{water}/kgₘₐₜₑᵣᵢₐₗ to about 0.3 kg_{water}/kgₘₐₜₑᵣᵢₐₗ at 90% of relative humidity.

In some embodiments, the water adsorption uptake is maintained through a plurality of cycles of adsorption/desorption. In some embodiments, the plurality of cycles of adsorption/desorption is at least 5, at least 10, at least 45, or at least 60.

In some embodiments, the material is obtained by pyrolysis at a temperature of about 500° C. to about 900° C. In some embodiments, wherein the pyrolysis is at a temperature of about 700° C.

In some embodiments, the material is obtained from curing of an organic compound and formaldehyde in the presence of at least one catalyst, wherein the organic compound is selected from resorcinol, urea, melamine, a tannin and combinations thereof. In some embodiments, the at least one catalyst is selected from alkaline salts, alkaline oxides, alkaline hydroxides, ammonia, carbonates, metal carbonyls, metal salts and mixtures thereof.

In some embodiments, the ratio of organic compound:formaldehyde:catalyst is about 1:1:0.01 to about 1:4:0.5. In some embodiments, the ratio of organic compound:formaldehyde:catalyst is about 2:3:0.01.

The present application also provides a process for preparing a nanoporous carbonaceous material, the process comprising:
curing organic carbonaceous reagents comprising C, N and O under conditions to obtain a polymeric matrix;
pyrolyzing the polymeric matrix to form the nanoporous carbonaceous material; and
optionally functionalizing the nanoporous carbonaceous material;
wherein the nanoporous carbonaceous material has an elemental content, in wt % based on total weight of the material, in carbon of about 85% to about 99.5%, oxygen of about 0.5% to about 10%, and nitrogen of about 0% to about 5%.

The present application further includes a process for preparing a nanoporous carbonaceous material, the process comprising:
curing an organic compound and formaldehyde under conditions to form at least one resorcinol-formaldehyde resin, wherein the organic compound is selected from resorcinol, urea, melamine, a tannin and combinations thereof;
pyrolyzing the at least one organic compound-formaldehyde resin to form the nanoporous carbonaceous material; and
optionally functionalizing the nanoporous carbonaceous material.

In some embodiments, the curing includes heating in the presence of at least one catalyst. In some embodiments, the curing includes heating at a temperature of 50° C. to 90° C. In some embodiments, the at least one catalyst is selected from alkaline salts, alkaline oxides, alkaline hydroxides, ammonia, carbonates, metal carbonyls, metal salts and mixtures thereof.

In some embodiments, the pyrolyzing is at a temperature from about 500° C. to about 900° C. In some embodiments, the pyrolyzing is at a temperature of about 700° C.

In some embodiments, the ratio of organic compound:formaldehyde:catalyst is about 1:1:0.1 to about 1:4:0.5. In some embodiments, the ratio of organic compound:formaldehyde:catalyst is about 2:3:0.01.

In some embodiments, optionally functionalizing is conducted prior and/or after pyrolyzing.

In some embodiments, the nanoporous carbonaceous material has an average pore size of about 1 to about 10 nm. In some embodiments, the average pore size is about 1.5 nm.

In some embodiments, the nanoporous carbonaceous material has a pore size distribution of about 1.3 nm to about 1.9 nm.

In some embodiments, the nanoporous carbonaceous material has a specific surface area of about 300 m²/g to about 550 m²/g. In some embodiments, the specific surface area is about 350 m²/g to about 525 m²/g.

In some embodiments, the nanoporous carbonaceous material has an average pore volume of about 0.20 cm³/g to about 0.50 cm³/g. In some embodiments, the average pore volume is about 0.23 cm³/g to about 0.35 cm³/g.

In some embodiments, the functionalizing comprises functionalization with at least one metal or at least one functional group selected from hydroxyl, carbonyl, carboxyl, amino, sulfhydryl, and phosphate groups. In some embodiments, the functionalizing comprises functionalization with at least one of nitrogen-based moieties, oxygen-based moieties, sulfur-based moieties, phosphor-based moieties, metal-based moieties or mixtures thereof.

In some embodiments, the at least one of nitrogen-based moieties, oxygen-based moieties, sulfur-based moieties, phosphor-based moieties, metal-based moieties or mixtures thereof are added prior and/or after the pyrolysis, in an amount from about 10% to about 50% (wt) based on total material. In some embodiments, the at least one of nitrogen-based moieties, oxygen-based moieties, sulfur-based moieties, phosphor-based moieties, metal-based moieties or mixtures thereof are added in an amount of about 40% (wt) based on total material.

In some embodiments, the nitrogen-based moieties is from a heterocyclic organic compound selected from phenathroline, pyridine, pyrrolidine, and pyrrole.

In some embodiments, the oxygen-based moieties is from air, pure oxygen, hydrogen peroxide, ozone, carbon dioxide, carbon monoxide or a mixture of O₂/N₂.

In some embodiments, the nanoporous carbonaceous material is selected from a nitrogen functionalized material, an oxygen functionalized material, or a nitrogen-oxygen functionalized material.

In some embodiments, the nanoporous carbonaceous material has an elemental content, in wt % based on total weight of the material, in carbon of about 86% to about 99%, oxygen of about 0.8% to about 9.5%, and nitrogen of about 0% to about 4.5%.

In some embodiments, the nanoporous carbonaceous material has a surface concentration, in wt % based on total weight of the material, in carbon of about 87% to about 95%, oxygen of about 4% to about 8% and nitrogen of about 0% to about 5%. In some embodiments, the nanoporous carbonaceous material has a surface concentration, in wt % based on total weight of the material, in carbon of about 88% to about 94%, oxygen of about 5% to about 8% and nitrogen of about 0% to about 4.5%.

In some embodiments, the nitrogen functionalized material has an elemental content, in wt % based on total weight of the material, in carbon of from about 95% to about 97%, oxygen of about 0.5% to about 1.5% and nitrogen of about 2% to about 3%.

In some embodiments, the oxygen functionalized material has an elemental content, in wt % based on total weight of the material, in carbon of from about 97% to about 98%, oxygen of about 2% to about 2.5% and nitrogen of about 0% to about 0.5%.

In some embodiments, the nitrogen-oxygen functionalized material has an elemental content, in wt % based on total weight of the material, in carbon of from about 85% to about 87%, oxygen of about 9% to about 10% and nitrogen of about 3% to about 5%.

In some embodiments, the nitrogen functionalized material has a surface concentration, in wt % based on total weight of the material, in carbon of about 90% to about 94%, oxygen of about 3% to about 6% and nitrogen of about 0.5% to about 4%.

In some embodiments, the oxygen functionalized material has a surface concentration, in wt % based on total weight of the material, in carbon of about 92% to about 94%, oxygen of about 6% to about 8% and nitrogen of about 0% to about 0.5%.

In some embodiments, the nitrogen-oxygen functionalized material has a surface concentration, in wt % based on total weight of the material, in carbon of about 87% to about 89%, oxygen of about 6% to about 8% and nitrogen of about 3% to about 5%.

In some embodiments, the nanoporous carbonaceous material has a water adsorption uptake of about 0.1 kg_{water}/kgₘₐₜₑᵣᵢₐₗ to about 0.2 kg_{water}/kgₘₐₜₑᵣᵢₐₗ at 40% of relative humidity. In some embodiments, the nanoporous carbonaceous material has a water adsorption uptake of about 0.1 kg_{water}/kgₘₐₜₑᵣᵢₐₗ to about 0.5 kg_{water}/kgₘₐₜₑᵣᵢₐₗ at 90% of relative humidity. In some embodiments, the nanoporous carbonaceous material has a water adsorption uptake of about 0.1 kg_{water}/kgₘₐₜₑᵣᵢₐₗ to about 0.3 kg_{water}/kgₘₐₜₑᵣᵢₐₗ at 90% of relative humidity.

In some embodiments, the water adsorption uptake is maintained through a plurality of cycles of adsorption/desorption. In some embodiments, the plurality of cycles of adsorption/desorption is at least 5, at least 10, at least 45, or at least 60.

Also provided is a nanoporous carbonaceous material prepared using the process of present application.

Included is a method to capture atmospheric water comprising;
adsorbing water from ambient atmosphere using a nanoporous carbonaceous material of the present application under conditions for uptake of the water into the nanoporous carbonaceous material.

Further included is a method of water-harvesting comprising;
adsorbing water from ambient atmosphere using a nanoporous carbonaceous material of the present application under conditions for uptake of the water into the nanoporous carbonaceous material;
applying energy to desorb water;
collecting the desorbed water.

In some embodiments, applying energy to desorb water comprises direct or indirect heating. In some embodiments, applying energy to desorb water comprises applying heat at a temperature of from 30° C. to 75° C. In some embodiments, applying energy comprises applying ultrasound or microwaves.

In some embodiments, collecting the desorbed water comprises condensing vapors.

Also provided is use of a nanoporous carbonaceous material of the present application for water harvesting.

The present application further includes use of a nanoporous carbonaceous material of the present application for atmospheric water harvesting.

Further provided is use of a nanoporous carbonaceous material of the present application for water adsorption.

Included is use of a nanoporous carbonaceous material of the present application for capillary condensation of water.

Also included is use of a nanoporous carbonaceous material of the present application for water uptake.

The present application further includes use of a nanoporous carbonaceous material of the present application for capturing atmospheric water.

The present application also includes use of a nanoporous carbonaceous material of the present application in the manufacture of a nanoporous sponge for atmospheric water harvesting.

Further provided is use of a nanoporous carbonaceous material of the present application for water treatment or purification.

The present application also provides use of a nanoporous carbonaceous material of the present application for dehumidification.

Further included is use of an organic compound/formaldehyde composition in the manufacture of a nanoporous sponge for atmospheric water harvesting, wherein the organic compound is selected from resorcinol, urea, melamine and a tannin.

The present application also includes use of an organic compound/formaldehyde composition in the manufacture of a nanoporous sponge for water adsorption, wherein the organic compound is selected from resorcinol, urea, melamine, a tannin and combinations thereof.

The present application further includes use of an organic compound/formaldehyde composition in the manufacture of a nanoporous carbonaceous material for atmospheric water harvesting, wherein the organic compound is selected from resorcinol, urea, melamine, a tannin and combinations thereof.

Further provided is use of an organic compound/formaldehyde composition in the manufacture of a nanoporous carbonaceous material for water adsorption, wherein the organic compound is selected from resorcinol, urea, melamine, a tannin and combinations thereof.

The present application also includes use of an organic compound/formaldehyde composition in the manufacture of a nanoporous carbonaceous material for water treatment or purification, wherein the organic compound is selected from resorcinol, urea, melamine, a tannin and combinations thereof.

Also included is use of an organic compound/formaldehyde composition in the manufacture of a nanoporous carbonaceous material for dehumidification, wherein the organic compound is selected from resorcinol, urea, melamine, a tannin and combinations thereof.

Further included is use of an organic compound/formaldehyde composition in the manufacture of a nanoporous sponge for atmospheric water harvesting, wherein the organic compound is any organic compound.

The present application also includes use of an organic compound/formaldehyde composition in the manufacture of a nanoporous sponge for water adsorption, wherein the organic compound is any organic compound.

The present application further includes use of an organic compound/formaldehyde composition in the manufacture of a nanoporous carbonaceous material for atmospheric water harvesting, wherein the organic compound is any organic compound.

Further provided is use of an organic compound/formaldehyde composition in the manufacture of a nanoporous carbonaceous material for water adsorption, wherein the organic compound is any organic compound.

The present application also includes use of an organic compound/formaldehyde composition in the manufacture of a nanoporous carbonaceous material for water treatment or purification, wherein the organic compound is any organic compound.

Also included is use of an organic compound/formaldehyde composition in the manufacture of a nanoporous carbonaceous material for dehumidification, wherein the organic compound is any organic compound.

Other features and advantages of the present application will become apparent from the following detailed description. It should be understood, however, that the detailed description and the specific examples, while indicating embodiments of the application, are given by way of illustration only and the scope of the claims should not be limited by these embodiments but should be given the broadest interpretation consistent with the description as a whole.

### BRIEF DESCRIPTION OF DRAWINGS

The embodiments of the application will now be described in greater detail with reference to the attached drawings in which:

FIG. 1 shows a representation of three pathways of the prior art[^{4]} to capture water, fog harvesting, humidity sorption and thermodynamic approach.

FIG. 2 is a graph showing comparison of the water uptake of different porous materials known in the art[^{11]}, at P/P₀=0.3, 0.6 and 0.9.

FIG. 3 shows a representation of a device of prior art[^{16]} (US20180171604) to harvest water from air with MOFs based on night and day cycles.

FIG. 4 shows BET isotherms for (a) NPS; (b) N-NPS; (c) 0-NPS; and (d) NO-NPS measured with N₂ at 77 K, according to exemplary embodiments of the application.

FIG. 5 shows graphs of pore size distribution of (a) NPS; (b) N-NPS; (c) O-NPS; and (d) NO-NPS obtained from N₂ isotherms, the line representing the critical pore size of 2.2 nm, according to exemplary embodiments of the application.

FIG. 6 shows a micrograph of non-functionalized NPS observed on a SEM with a scale of 10 μm, according to exemplary embodiments of the application.

FIG. 7 shows an XPS survey for NO-NPS showing peaks for carbon C1s, nitrogen N1s and oxygen O1s, according to exemplary embodiments of the application.

FIG. 8 shows a graph of water uptake for the NPS samples at 90% relative humidity and 25° C., according to exemplary embodiments of the application.

FIG. 9 shows a graph of water adsorption over time for NO-NPS sample at 40% relative humidity and 25° C., according to exemplary embodiments of the application.

FIG. 10 shows a graph of water uptake of O-NPS sample over cycles of adsorption/desorption, according to exemplary embodiments of the application.

FIG. 11 shows adsorption and desorption isotherms for (a) NPS; (b) N-NPS; (c) O-NPS; and (d) NO-NPS, according to exemplary embodiments of the application.

FIG. 12 shows a graph of desorption and recovery of water from non-functionalized NPS depending on the desorption temperature, according to exemplary embodiments of the application.

FIG. 13 shows a photograph of NPS samples before (left) and after pyrolysis (right), according to exemplary embodiments of the application.

FIG. 14 shows a micrograph of NPS synthesized in concentrated conditions, according to exemplary embodiments of the application.

FIG. 15 shows a micrograph of O-NPS synthesized in concentrated conditions, according to exemplary embodiments of the application.

FIG. 16 shows water adsorption isotherms fitted with DDN model for (a) NPS; (b) N-NPS; (c) O-NPS; and (d) NO-NPS samples, according to exemplary embodiments of the application.

FIG. 17 shows NPS isotherm recorded at 30° C. in the DVS (a) and in the environmental chamber (b), according to exemplary embodiments of the application.

FIG. 18 shows adsorption/desorption isotherms for NPS recorded in the environmental chamber at three different temperatures, according to exemplary embodiments of the application.

FIG. 19 shows adsorption isotherms for NPS recorded in the environmental chamber at four different temperatures, according to exemplary embodiments of the application.

FIG. 20 shows a graph of adsorption/desorption cycle for NPS over time, wherein pale lines are measurements of temperature and relative humidity, while the dark line refers to the water uptake, according to exemplary embodiments of the application.

FIG. 21 shows a graph of mass evolution of the NPS over 61 adsorption/desorption cycles recorded at a temperature of 25° C., the cycles being recorded from different tests, according to exemplary embodiments of the application.

FIG. 22 shows a graph of DVS measurements on NPS showing the mass evolution depending on the targeted relative humidity, measurements performed at 30° C. on a 1 mg sample, according to exemplary embodiments of the application.

FIG. 23 shows fitting graphs of Equation 4 at the relative humidity values of (a) 5%; (b) 35%; (c) 65%; and (d) 95%, from DVS data converted from mass change to fraction water uptake, according to exemplary embodiments of the application.

FIG. 24 shows a graph of adsorption kinetics for NPS based on the linear driving force model, where the solid line represents the kinetics based on the average diffusion coefficient and the dotted lines take into account the upper and lower values of diffusion coefficient, according to exemplary embodiments of the application.

FIG. 25 shows a graph of adsorption kinetics for NPS based on the linear driving force model for different particle sizes: 1.9 μm for darker line, 5 μm for middle line, 10 μm for paler line, where the solid line represents the kinetics based on the average diffusion coefficient and the dotted lines take into account the upper and lower values of diffusion coefficient, according to exemplary embodiments of the application.

FIG. 26 shows a graph of characteristic void size in function of the packing porosity for particle radius of 1.9, 5 and 10 micrometer, where the dashed lines correspond to the range of packing porosity found for the NPS, according to exemplary embodiments of the application.

FIG. 27 shows a graph of Knudsen diffusion coefficient for particles of 1.9 μm at temperatures from 300 to 380 K; where the dashed lines correspond to the range of packing porosity found for the NPS, according to exemplary embodiments of the application.

FIG. 28 shows a graph of water concentration evolution in the adsorbent layer at different times, according to exemplary embodiments of the application.

FIG. 29 shows a graph of time evolution of the water concentration at a layer position of L=0.01 m, according to exemplary embodiments of the application.

FIG. 30 shows graphs of time evolution of the water concentration of the inter-particle diffusion region (a); and intra-particle diffusion region (b), according to exemplary embodiments of the application.

FIG. 31 shows a graph of temperature evolution in the adsorbent layer at different times, according to exemplary embodiments of the application.

FIG. 32 shows adsorption isotherms measured at 30° C. for the sorbents of Example 3, according to exemplary embodiments of the application.

FIG. 33 shows a graph of Gibbs free energy of the sorbents based on their moisture content of Example 3, according to exemplary embodiments of the application.

FIG. 34 shows a graph of net isosteric heat of adsorption depending on the moisture content for the sorbents of Example 3, according to exemplary embodiments of the application.

FIG. 35 shows a graph of integral enthalpy of adsorption of the sorbents of Example 3, according to exemplary embodiments of the application.

FIG. 36 shows a graph of differential entropy of the sorbents of Example 3 and enhanced view of the low moisture content region, according to exemplary embodiments of the application.

FIG. 37 shows a graph of integral entropy of the sorbents of Example 3, according to exemplary embodiments of the application.

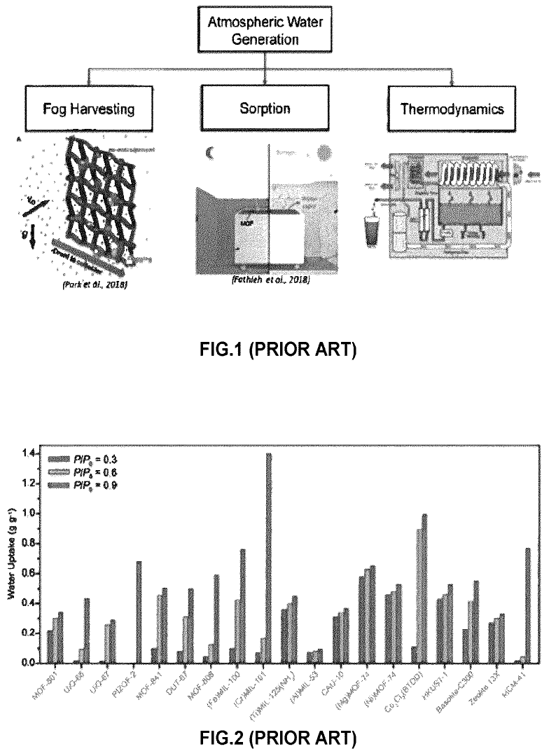

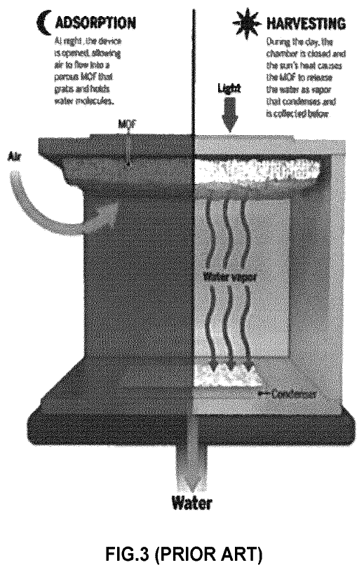

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present application, the singular forms “a”, “an” and “the” include plural references unless the content clearly dictates otherwise.

In embodiments comprising an “additional” or “second” component, such as an additional or second compound, the second component as used herein is chemically different from the other components or first component. A “third” component is different from the other, first, and second components, and further enumerated or “additional” components are similarly different.

As used in this application and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “consisting” and its derivatives as used herein are intended to be closed terms that specify the presence of the stated features, elements, components, groups, integers, and/or steps, and also exclude the presence of other unstated features, elements, components, groups, integers and/or steps.

The term “consisting essentially of”, as used herein, is intended to specify the presence of the stated features, elements, components, groups, integers, and/or steps as well as those that do not materially affect the basic and novel characteristic(s) of these features, elements, components, groups, integers, and/or steps.

The term “suitable” as used herein means that the selection of the particular composition or conditions would depend on the specific steps to be performed, the identity of the components to be transformed and/or the specific use for the compositions, but the selection would be well within the skill of a person trained in the art.

The present description refers to a number of chemical terms and abbreviations used by those skilled in the art. Nevertheless, definitions of selected terms are provided for clarity and consistency.

The terms “about”, “substantially” and “approximately” as used herein mean a reasonable amount of deviation of the modified term such that the end result is not significantly changed. These terms of degree should be construed as including a deviation of at least ±10% of the modified term if this deviation would not negate the meaning of the word it modifies or unless the context suggests otherwise to a person skilled in the art.

The term “sustainably” as used herein means in a way that can be sustained in time, i.e. that the results may be maintained at a certain rate or level over time.

The term “aq.” as used herein refers to aqueous.

The term “alkyl” as used herein, whether it is used alone or as part of another group, means a straight or branched chain, saturated, unsubstituted or substituted alkyl group. The number of carbon atoms that are possible in the referenced alkyl group are indicated by the prefix “Cₙ₁₋ₙ₂”. For example, the term C₁₋₄alkyl means an alkyl group having 1, 2, 3 or 4 carbon atoms.

The term “aryl” as used herein, whether it is used alone or as part of another group, refers to carbocyclic groups containing at least one aromatic ring. Aryl groups are either unsubstituted or substituted.

The term “heteroaryl” as used herein, whether it is used alone or as part of another group, refers to cyclic groups containing at least one heteroaromatic ring in which one or more of the atoms are a heteroatom selected from 0, S and N and the remaining atoms are C. Heteroaryl groups are either unsubstituted or substituted.

The term “alkylene”, whether it is used alone or as part of another group, means a straight or branched chain, saturated, unsubstituted or substituted alkylene group, that is, a saturated carbon chain that contain substituents on two or more of its ends. The number of carbon atoms that are possible in the referenced alkylene group are indicated by the prefix “Cₙ₁₋ₙ₂”. For example, the term C₁₋₆alkylene means an alkylene group having 1, 2, 3, 4, 5 or 6, carbon atoms.

The term “alkenylene”, whether it is used alone or as part of another group, means a straight or branched chain, unsaturated, unsubstituted or substituted alkylene group, that is, an unsaturated carbon chain that contains substituents on two or more of its ends and at least one double bond. The number of carbon atoms that are possible in the referenced alkenylene group are indicated by the prefix “Cₙ₁₋ₙ₂”. For example, the term C₂₋₆alkylene means an alkylene group having 2, 3, 4, 5 or 6, carbon atoms.

The term “alkynylene”, whether it is used alone or as part of another group, means a straight or branched chain, unsaturated, unsubstituted or substituted alkylene group, that is, an unsaturated carbon chain that contains substituents on two or more of its ends and at least one triple bond. The number of carbon atoms that are possible in the referenced alkynylene group are indicated by the prefix “Cₙ₁₋ₙ₂”. For example, the term C₂₋₆alkynylene means an alkylene group having 2, 3, 4, 5 or 6, carbon atoms.

The term “cycloalkylene”, whether it is used alone or as part of another group, means an unsubstituted or substituted cycloalkylene group, that is, a saturated carbocycle that contains substituents on two or more of its ends. The number of carbon atoms that are possible in the referenced cycloalkylene group are indicated by the prefix “Cₙ₁₋ₙ₂”. The cycloalkylene group is either monocyclic or polycyclic, with polycyclic rings being either bridged, fused, spirocyclic or linked by a bond.

The term “arylene”, whether it is used alone or as part of another group, means an unsubstituted or substituted arylene group, that is, an unsaturated carbocycle that contains at least one aromatic ring and substituents on two or more of its ends. The arylene group is either monocyclic or polycyclic, with polycyclic rings being either bridged, fused, spirocyclic or linked by a bond.

The term “heteroarylene”, whether it is used alone or as part of another group, means an unsubstituted or substituted heteroarylene group, that is, a cyclic group containing at least one heteroaromatic ring in which one or more of the atoms are a heteroatom selected from O, S and N and the remaining atoms are C, and substituents on two or more of its ends. The heteroarylene group is either monocyclic or polycyclic, with polycyclic rings being either bridged, fused, spirocyclic or linked by a bond.

The term “aryl-based” in reference to a polyphosphonic acid means that the phosphonic acid groups are substituents on one or more aryl rings which, in the case of two or more aryl rings, are either fused or linked together by a linker group.

The term “heteroaryl-based” in reference to a polyphosphonic acid means that the phosphonic acid groups are substituents on one or more heteroaryl rings which, in the case of two or more aryl rings are either fused or linked together by a linker group.

The term, “aryl- and heteroaryl-based” in reference to a polyphosphonic acid means that the phosphonic acid groups are substituents on a ring structure that comprises at least one aryl and at least one heteroaryl ring, which are either fused or linked together by a linker group.

The term “substituted” as used herein means that one or more available hydrogen atoms in a referenced group are replaced with a substituent.

The term “available”, as in “available hydrogen atoms”, refers to hydrogen atoms that would be known to a person skilled in the art to be capable of replacement by another atom or group.

The terms “metal-organic framework” or “MOF” as used herein refer to a class of compounds comprising metal ions or clusters coordinated to organic ligands to form one-, two-, or three-dimensional structures containing potential voids (pores).

The terms “resin” as used herein refers to a class of materials comprising a mixture of organic compounds convertible into polymers.

The terms “porous” or “porosity” as used herein refer to the void (i.e. “empty”) spaces in a material.

The term “nanosponge” or “NPS” as used herein refer to carbonaceous material having a nanoporous structure, according to the present application.

### II. Materials of the Application

It has been surprisingly shown herein that nanoporous carbonaceous material of the present application provide highly stable water adsorbent material at a low cost, requiring minimal energy to prepare and to operate. The nanoporous carbonaceous material of the present application provide for high water uptake and fast adsorption kinetics. Comparable materials and processes did not display the same properties, highlighting the surprising results obtained with the materials and processes of the application.

Accordingly, the present application includes a nanoporous carbonaceous material comprising an elemental content, in wt % based on total weight of the material, in carbon of about 85% to about 99.5%, oxygen of about 0.5% to about 10%, and nitrogen of about 0% to about 5%, and wherein the material is optionally functionalized.

The present application also includes a nanoporous carbonaceous material for use in water adsorption, the material comprising an elemental content, in wt % based on total weight of the material, in carbon of about 85% to about 99.5%, oxygen of about 0.5% to about 10%, and nitrogen of about 0% to about 5%, and wherein the material is optionally functionalized.

The present application further provides a nanoporous carbonaceous material comprising at least one pyrolyzed organic compound-formaldehyde resin, wherein the organic compound is selected from resorcinol, urea, melamine, a tannin and combinations thereof, wherein the material is optionally functionalized.

The present application further provides a nanoporous carbonaceous material comprising at least one pyrolyzed organic compound-formaldehyde resin, wherein the organic compound is any organic compound, wherein the material is optionally functionalized.

The present application also provides a nanoporous carbonaceous material for use in water adsorption, the material comprising at least one pyrolyzed resorcinol-formaldehyde resin, wherein the material is optionally functionalized.

In some embodiments, the nanoporous carbonaceous material has an average pore size of about 1 to about 10 nm. In some embodiments, the nanoporous carbonaceous material has an average pore size is about 1.5 nm. A skilled person in the art would know that the pore size may vary according to different conditions. In some embodiments, the average pore size is below the critical pore size of 2.2 nm for water at room temperature, to allow for reversibility of adsorption, thus requiring minimal energy to desorb water.

In some embodiments, the nanoporous carbonaceous material has a pore size distribution of between about 1.3 nm to about 1.9 nm. It will be appreciated that a narrow pore size distribution is preferable for good reversibility, i.e. reversibility between the adsorption and desorption.

In some embodiments, the nanoporous carbonaceous material has a specific surface area of about 300 m²/g to about 550 m²/g. In some embodiments, the specific surface area is about 350 m²/g to about 525 m²/g.

In some embodiments, the nanoporous carbonaceous material has an average pore volume of about 0.20 cm³/g to about 0.50 cm³/g. In some embodiments, the average pore volume is about 0.23 cm³/g to about 0.35 cm³/g.

Without being bound to theory, it will be understood that kinetics of water adsorption are controlled by the pore size, pore size distribution, size of the adsorbent particles, such as diameter, and surface chemistry of the available surface area. The nanoporous carbonaceaous material of the present application have demonstrated fast adsorption kinetics.

The nanoporous carbonaceous material may be obtained from pyrolysis, for example of a resin. However, an unfavorable effect of the pyrolysis can also be observed: most of the oxygen-based functional groups initially present in the resin are eliminated by the heat treatment, leaving a material with 95 wt % of carbon. Without being bound to theory, functional groups are beneficial to promote water nucleation on

the available surface area [11] and include non-exhaustively hydroxyl, carbonyl, ketonic, carboxyl, amino, sulfhydryl, phosphate groups. As such, functionalization may be included in order to improve the amount of functional groups in the material.

In some embodiments, the nanoporous carbonaceous material is functionalized with at least one functional group selected from hydroxyl, carbonyl, carboxyl, amino, sulfhydryl, and phosphate groups. In some embodiments, the nanoporous carbonaceous material is functionalized with at least one of nitrogen-based moieties, oxygen-based moieties, sulfur-based moieties, phosphor-based moieties, metal-based moieties or mixtures thereof.

In some embodiments, the at least one of nitrogen-based moieties, oxygen-based moieties, sulfur-based moieties, phosphor-based moieties, metal-based moieties or mixtures thereof are added before or after the pyrolysis. For example, a first approach may consist in adding a molecule containing nitrogen functional groups in the original mixture before curing the resin and pyrolyzing it. A second approach may include adding oxygen functionalities through an oxidation step where the material is heated in presence of air after the initial pyrolysis. Finally, the two approaches may be combined together to introduce both N and O functionalization. Alternate functionalization approaches known in the art may be used, for example the use of non-thermal plasma post-processing, acidic treatment, and this is well within the purview of a skilled person.

In some embodiments, the at least one of nitrogen-based moieties, oxygen-based moieties, sulfur-based moieties, phosphor-based moieties, metal-based moieties or mixtures thereof are added in an amount from about 10% to about 50% (wt) based on total material. In some embodiments, the at least one of nitrogen-based moieties, oxygen-based moieties, sulfur-based moieties, phosphor-based moieties, metal-based moieties or mixtures thereof are added in an amount of about 40% (wt) based on total material.

In some embodiments, the nitrogen-based moieties is from phenathroline. In some embodiments, the oxygen-based moieties is air, pure oxygen, hydrogen peroxide, ozone, carbon dioxide, carbon monoxide or a mixture of O₂/N₂ at various concentrations.

In some embodiments, the nanoporous carbonaceous material is selected from a nitrogen functionalized material, an oxygen functionalized material, or a nitrogen-oxygen functionalized material.

In some embodiments, the nanoporous carbonaceous material has an elemental content, in wt % based on total weight of the material, in carbon of about 86% to about 99%, oxygen of about 0.8% to about 9.5%, and nitrogen of about 0% to about 4.5%.

In some embodiments, the nanoporous carbonaceous material has a surface concentration, in wt % based on total weight of the material, in carbon of about 87% to about 95%, oxygen of about 4% to about 8% and nitrogen of about 0% to about 5% .

In some embodiments, the nanoporous carbonaceous material has a surface concentration, in wt % based on total weight of the material, in carbon of about 88% to about 94%, oxygen of about 5% to about 8% and nitrogen of about 0% to about 4.5%.

In some embodiments, the nitrogen functionalized material has an elemental content, in wt % based on total weight of the material, in carbon of from about 95% to about 97%, oxygen of about 0.5% to about 1.5% and nitrogen of about 2% to about 3%. In some embodiments, the nitrogen functionalized material has a surface concentration, in wt % based on total weight of the material, in carbon of about 90% to about 94%, oxygen of about 3% to about 6% and nitrogen of about 0.5% to about 4%.

In some embodiments, the oxygen functionalized material has an elemental content, in wt % based on total weight of the material, in carbon of from about 97% to about 98%, oxygen of about 2% to about 2.5% and nitrogen of about 0% to about 0.5%. In some embodiments, the oxygen functionalized material has a surface concentration, in wt % based on total weight of the material, in carbon of about 92% to about 94%, oxygen of about 6% to about 8% and nitrogen of about 0% to about 0.5%.

In some embodiments, the nitrogen-oxygen functionalized material has an elemental content, in wt % based on total weight of the material, in carbon of from about 85% to about 87%, oxygen of about 9% to about 10% and nitrogen of about 3% to about 5%. In some embodiments, the nitrogen-oxygen functionalized material has a surface concentration, in wt % based on total weight of the material, in carbon of about 87% to about 89%, oxygen of about 6% to about 8% and nitrogen of about 3% to about 5% .

In some embodiments, the nanoporous carbonaceous material has a water adsorption uptake is from about 0.1 kg_{water}/kgₘₐₜₑᵣᵢₐₗ to about 0.2 kg_{water}/kgₘₐₜₑᵣᵢₐₗ at 40% of relative humidity. In some embodiments, the water adsorption uptake is from about 0.1 kg_{water}/kgₘₐₜₑᵣᵢₐₗ to about 0.5 kg_{water}/kgₘₐₜₑᵣᵢₐₗ,or about 0.1 kg_{water}/kgₘₐₜₑᵣᵢₐₗ to about 0.3 kg_{water}/kgₘₐₜₑᵣᵢₐₗ at 90% of relative humidity. Without being bound to theory, it will be appreciated that the presence of oxygen functionalization seems to increase the water uptake of the nanoporous carbonaceous material of the present application.

An important characteristic of adsorbents to capture atmospheric water is the cyclability of the material, meaning keeping constant performance over adsorption and desorption cycles. For example, MOFs adsorbents typically show significant loss of performance after successive cycles. In some embodiments, the nanoporous carbonaceous material of the present application has a water adsorption substantially constant through a plurality of cycles of adsorption/desorption. In some embodiments, the plurality of cycles of adsorption/desorption is at least 5, or at least 10, at least 45, or at least 60. In some embodiments, the plurality of cycles is about 5 to about 100 cycles, or about 5 to about 1000 cycles.

In some embodiments, the material is obtained by pyrolysis at a temperature of about 500° C. to about 900° C. In some embodiments, the pyrolysis is at a temperature of about 700° C. In some embodiments, the pyrolyzing is at a temperature from about 750° C. to about 850° C. In some embodiments, the pyrolyzing is at a temperature of about 800° C. In some embodiments, the pyrolysis is conducted under an atmosphere of CO₂, CO, N₂, NH₃, or a noble gas, including He, Ne, Kr, Xe, Rn. In some embodiments, the pyrolysis is conducted under a CO₂ atmosphere.

In some embodiments, the material is obtained from curing of an organic compound and formaldehyde in the presence of at least one catalyst. In some embodiments, the material is obtained from curing of an organic compound and formaldehyde in the presence of at least one catalyst, wherein the organic compound is selected from resorcinol, urea, melamine, a tannin and combinations thereof. In some embodiments, the at least one catalyst is selected from alkaline salts, such as sodium carbonate, alkaline oxides and hydroxides, such as sodium hydroxide, metal carbonyls, metal salts, or ammonia: It will be appreciated that any catalyst suitable for curing may be used.

In some embodiments, the ratio of organic compound:formaldehyde:catalyst is from 1:1:0.01 to 1:4:0.5. In some embodiments, the ratio of organic compound:formaldehyde:catalyst is about 2:3:0.01.

### III. Processes for the Application

The present application provides a process for preparing a nanoporous carbonaceous material, the process comprising:
curing organic carbonaceous reagents comprising C, N and O under conditions to obtain a polymeric matrix;
pyrolyzing the polymeric matrix to form the nanoporous carbonaceous material; and
optionally functionalizing the nanoporous carbonaceous material;
wherein the nanoporous carbonaceous material has an elemental content, in wt % based on total weight of the material, in carbon of about 85% to about 99.5%, oxygen of about 0.5% to about 10%, and nitrogen of about 0% to about 5%.

The present application further provides a process for preparing a nanoporous carbonaceous material, the process comprising:
curing an organic compound and formaldehyde under conditions to form at least one organic compound-formaldehyde resin, wherein the organic compound is selected from resorcinol, urea, melamine, a tannin and combinations thereof;
pyrolyzing the at least one resorcinol-formaldehyde resin to form the nanoporous carbonaceous material; and
optionally functionalizing the nanoporous carbonaceous material.

In some embodiments, the curing includes heating in the presence of at least one catalyst. In some embodiments, the curing includes heating at a temperature of 50° C. to 90° C.

In some embodiments, the components used in the curing may be added in any order. The order of addition may affect the rate of the reaction and this is well within the purview of a skilled person in the art. In some embodiments, the curing product forms a gel or a solid that is isolated to be used for further processing. In some embodiments, a solvent phase is evaporated to recuperate any curing product that may be present in the solvent phase.

In some embodiments, the pyrolyzing is at a temperature from about 500° C. to about 900° C. In some embodiments, the pyrolyzing is at a temperature of about 700° C. In some embodiments, the pyrolyzing is at a temperature from about 750° C. to about 850° C. In some embodiments, the pyrolyzing is at a temperature of about 800° C. In some embodiments, the pyrolysis is conducted under an atmosphere of CO₂, CO, N₂, NH₃, or a noble gas, including He, Ne, Kr, Xe, or Rn. In some embodiments, the pyrolysis is conducted under a CO₂ atmosphere.

In some embodiments, the process further comprises crushing the polymeric matrix or resorcinol-formaldehyde resin prior to pyrolyzing.

In some embodiments, the at least one catalyst is selected from sodium carbonate, In some embodiments, the ratio of organic compound:formaldehyde:catalyst is from 1:1:0.01 to 1:4:0.5. In some embodiments, the ratio of organic compound:formaldehyde:catalyst is about 2:3:0.01.

In some embodiments, optionally functionalizing is conducted prior and/or after pyrolyzing.

The nanoporous carbonaceous material prepared according to the process of the present application has the properties as described above.

The present application also includes nanoporous material as described in any aspect or embodiment herein. In some embodiments, the nanoporous material is as prepared according to any process of any previous aspect and embodiment herein. In embodiments, the nanoporous material is as characterized according to any one of the figures.

### IV. Methods and Uses of the Application

The processes of the application produce highly stable, ordered and nanoporous material. The nanoporous material of the present application have a wide range of applications.

Accordingly, the present application includes a method to capture atmospheric water comprising;
adsorbing water from ambient atmosphere using a nanoporous carbonaceous material of the present application under conditions for uptake of the water in-to the nanoporous carbonaceous material.

The present application also includes a method of water-harvesting comprising;
adsorbing water from ambient atmosphere using a nanoporous carbonaceous material of the present application under conditions for uptake of the water in-to the nanoporous carbonaceous material;
applying energy to desorb water;
collecting the desorbed water.

In some embodiments, applying energy to desorb water comprises heating directly or indirectly. In some embodiments, heating comprises directly applying heat to the material. In some embodiments, heating comprises indirectly increasing the temperature of the material by applying a current of hot air. In some embodiments, applying energy to desorb water comprises applying heat at a temperature of from 20° C. to 75° C., or from 30° C. to 75° C. In some embodiments, applying energy to desorb water comprises applying ultrasound or microwaves.

In some embodiments, collecting the desorbed water comprises condensing vapors.

The present application also includes use of a nanoporous carbonaceous material of the present application for water harvesting.

The present application also includes use of a nanoporous carbonaceous material of the present application for atmospheric water harvesting.

Also provided is use of a nanoporous carbonaceous material of the present application for water adsorption.

The present application also includes use of a nanoporous carbonaceous material of the present application for capillary condensation of water.

The present application further includes use of a nanoporous carbonaceous material of the present application for water uptake.

The present application also provides use of a nanoporous carbonaceous material of the present application for capturing atmospheric water.

The present application also includes use of a nanoporous carbonaceous material of the present application in the manufacture of a nanoporous sponge for atmospheric water harvesting.

The present application also includes use of a nanoporous carbonaceous material of the present application for water treatment or purification.

The present application also includes use of a nanoporous carbonaceous material of the present application for dehumidification.

Also included is use of an organic compound/formaldehyde composition in the manufacture of a nanoporous sponge for atmospheric water harvesting, wherein the organic compound is selected from resorcinol, urea, melamine, a tannin and combinations thereof.

The present application provides use of an organic compound/formaldehyde composition in the manufacture of a nanoporous sponge for water adsorption, wherein the organic compound is selected from resorcinol, urea, melamine, a tannin and combinations thereof.

The present application also provides use of an organic compound/formaldehyde composition in the manufacture of a nanoporous carbonaceous material for atmospheric water harvesting, wherein the organic compound is selected from resorcinol, urea, melamine, a tannin and combinations thereof.

The present application further includes use of an organic compound/formaldehyde composition in the manufacture of a nanoporous carbonaceous material for water adsorption, wherein the organic compound is selected from resorcinol, urea, melamine, a tannin and combinations thereof.

The present application further includes use of an organic compound/formaldehyde composition in the manufacture of a nanoporous carbonaceous material for water treatment or purification, wherein the organic compound is selected from resorcinol, urea, melamine, a tannin and combinations thereof.

The present application further includes use of an organic compound/formaldehyde composition in the manufacture of a nanoporous carbonaceous material for dehumidification, wherein the organic compound is selected from resorcinol, urea, melamine, a tannin and combinations thereof.

Also included is use of an organic compound/formaldehyde composition in the manufacture of a nanoporous sponge for atmospheric water harvesting, wherein the organic compound is any organic compound.

The present application provides use of an organic compound/formaldehyde composition in the manufacture of a nanoporous sponge for water adsorption, wherein the organic compound is any organic compound.

The present application also provides use of an organic compound/formaldehyde composition in the manufacture of a nanoporous carbonaceous material for atmospheric water harvesting, wherein the organic compound is any organic compound.

The present application further includes use of an organic compound/formaldehyde composition in the manufacture of a nanoporous carbonaceous material for water adsorption, wherein the organic compound is any organic compound.

The present application further includes use of an organic compound/formaldehyde composition in the manufacture of a nanoporous carbonaceous material for water treatment or purification, wherein the organic compound is any organic compound.

The present application further includes use of an organic compound/formaldehyde composition in the manufacture of a nanoporous carbonaceous material for dehumidification, wherein the organic compound is any organic compound.

### EXAMPLES

The following non-limiting examples are illustrative of the present application.

### General Methods

### Example 1

Material synthesis

The nanoporous materials, or nanoporous sponges (NPS), consist of resorcinol-formaldehyde (RF) resin that undergoes heat treatments. The resin is first synthesized through wet chemistry, where resorcinol, formaldehyde and a catalyst (sodium carbonate) are dissolved in a solvent consisting of a 1:1 mixture of water and ethanol. By heating this mixture at 80° C. over 24 h, resorcinol and formaldehyde polymerize into a porous matrix and the solvent is evaporated. It is recognized in literature that the pore size of RF-resins is dependent on the resorcinol to formaldehyde

ratio, nature of the catalyst and viscosity of the solution [18]. Trace amounts of catalysts are required for the resin to be cured. A mass ratio of resorcinol/formaldehyde/sodium carbonate of 2:3:0.01 was chosen as an exemplary embodiment. The RF resin may be used directly or ground prior to the pyrolysis step.

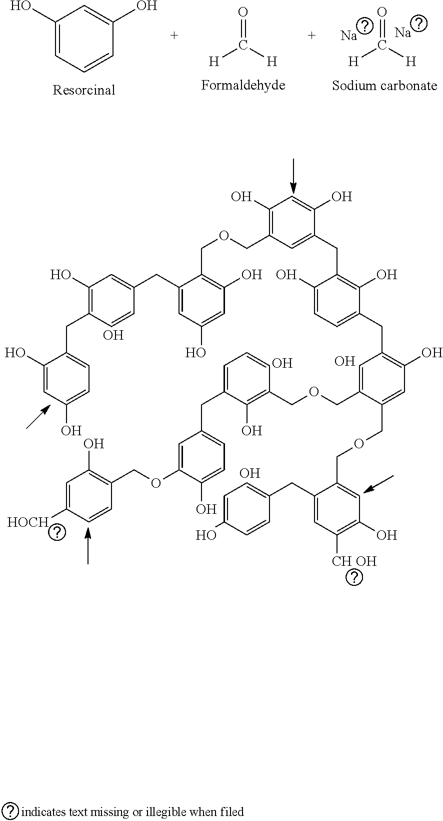

Pyrolysis in an inert atmosphere carbonizes the resin at 700° C. for 1 h, forming a sample of nanoporous sponge. Pyrolysis causes the pores to shrink to the required size. However, a secondary unfavorable effect of the pyrolysis can also be observed: most of the oxygen-based functional groups initially present in the resin are eliminated by the heat treatment, leaving a material with 95 wt % of carbon. Functional groups are beneficial to promote water nucleation on the available surface [13]. In order to improve the amount of functional groups in the material under the form of nitrogen and oxygen moieties, variations in the synthesis protocol may be included.

A first approach consists in adding a molecule containing N functional groups, phenanthroline, in the original mixture before curing the resin and pyrolyzing it. The phenanthroline molecule has been chosen for its molecular structure able to incorporate into the carbon matrix [19]. The mass concentration was selected at 40 wt % relative to the RF-resin. Following this technique, N-functionalized NPS (N-NPS) were produced. A second approach was to add O functionalities through an oxidation step where the material is heated at 700° C. for 1 h in presence of air, resulting in O-functionalized NPS (0-NPS). Finally, the two approaches may be combined together to get N/O-functionalized NPS (NO-NPS). A third approach consisted of conducting the pyrolysis step under a CO₂ atmosphere, at 800° C. (NPS-CO₂).

### Physical Characterization

The NPS samples were characterized for their pore size, pore volume and specific surface area through the Brunauer-Emmett-Teller (BET) technique. A Quantachrome Autosorb™-1 gas sorption analyzer measured the evolution of the mass uptake depending of the gas relative pressure at a temperature of 77K using N₂ as the adsorbate, after degassing overnight at 200° C. under vacuum. The elemental composition of the NPS surface and bulk with X-Ray Photoelectron Spectroscopy (XPS) and elemental analysis were conducted. X-ray Photoelectron Spectroscopy was performed on a Scientific K-Alpha XPS system from Thermo Scientific with an Al X-ray source, a 400 μm spot size, and Advantage software. The elemental analysis has been performed on a Truspec™ Micro analyzer from LECO to determine the relative quantities of C, H, and N with infrared sensors to detect gaseous CO₂ and H₂O, and thermal conductivity sensor for N₂. The complementary module Micro O from LECO detected CO₂ with an infrared sensor to determine O concentrations. Non-functionalized NPS sample were analyzed by scanning electron microscopy (SEM) using a JEOL™ 7600TFE operated at 10 kV.

### Water Adsorption

The samples have been tested in a custom-made environmental chamber with humidity and temperature control. Tests are performed at 90% of relative humidity (RH) and a temperature of 25° C. 10 to 100 mg of NPS are initially dried in the oven at 150° C. before being placed in a petri dish in the environmental chamber. The weight of the samples is measured prior the test and every 10 min to determine the mass evolution over time. Adsorption isotherms are also obtained on a dynamic vapor sorption (DVS) Intrinsic from Surface Measurement Systems Ltd., UK. Samples were equilibrated at 0% RH to determine dry mass followed by increments of 5% RH up to 95% RH, and brought back down to 0% RH for desorption measurement. The mass change is recorded at each increment once equilibrium was reached with an error of ±0.1 μg.

### Fitting of the Adsorption Isotherms

The experimental adsorption isotherms have been fitted to the theoretical Do and Do equation modified by Neitsch et al (DDN) [20]-[23]. This equation describes the adsorption process of H₂O on C as a two-step mechanism. The first step corresponds to the adsorption of the water molecules on the primary sites that are functional groups on the surface of the material. Water clusters grow around these primary sites via hydrogen bonds. The second step happens when cluster reach a threshold of 6 molecules and break down into water pentamers that fill the micropores. It has been shown by Neitsch et al. that pentamers can be generalized into m-mers for higher accuracy [21]. The equation describing water adsorption is then the following:

$$a = {a}_{0} \frac{{K}_{f} {\sum }_{n = 1}^{N} n {h}^{n}}{1 + {K}_{f} {\sum }_{n = 1}^{N} {h}^{n}} + {a}_{μ s} \frac{{K}_{μ} {h}^{m}}{1 + {K}_{μ} {h}^{m}} \qquad ( Equation 1 )$$

where a is the water uptake in mol/g, a₀ is the concentration of surface active sites in mol/g, a_{μs} is the saturation concentration in the micropores in mol/g, K_{f} is the chemisorption equilibrium constant, K_{μ}is the micropore equilibrium constant, N is the maximum number of water molecules adsorbed per surface site, m is the size of the water m-mers that desorb from clusters and fill the micropores, and h is the relative pressure. To fit the experimental data with the theoretical equation, the least-square method using the determination coefficient R² as follow:

$${R}^{2} = 1 \frac{\sum {( {a}_{e x p} - {a}_{t h} )}^{2}}{\sum {( {a}_{e x p} - \overline{{a}_{e x p}} )}^{2}} \qquad ( Equation 2 )$$

where aₑₓₚ are the experimental data, aₜₕ the corresponding theoretical data, and a̅ₑ̅ₓ̅ₚ̅ the average of experimental data over the relative pressure range.

### Scaled-Up Prototype

The water adsorption properties of the non-functionalized NPS measured at small scale (<100 mg) were then validated at larger scale with a custom-made water capture set-up. The moist air is generated by a boiler and controlled flow rate is passed through the porous material, until saturation of the sponge. The NPS is contained in an insulated column with glass wool. Water desorption is accomplished through mild heating from a heating tape coiled around the column to release the water. Supersaturated steam is then condensed with a water-cooling condenser.

The laboratory water capture set-up was validated with well-known desiccant (silica gel) as a control adsorbent. This scaled-up prototype can accommodate tens of grams of NPS and provide the amount of water collected per adsorption and desorption cycle.

### Results

### Porosity and Structure

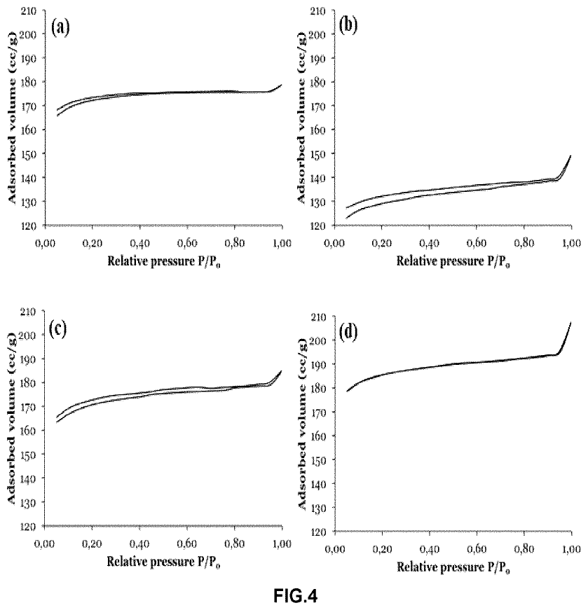

Almost no hysteresis is observed between the adsorption and desorption process in the presence of N₂ (isotherms are shown in FIG. 4).

TABLE 1
Summary of surface area, pore size and pore
volume for the various NPS samples.

| Sample | NPS | N—NPS | O—NPS | NO—NPS |
|---|---|---|---|---|
| Surface area (m²/g) | 487 | 347 | 484 | 527 |
| Average pore size (nm) | 1.5 ± 0.2 | 1.5 ± 0.2 | 1.7 ± 0.2 | 1.7 ± 0.2 |
| Pore volume (cm³/g) | 0.276 | 0.231 | 0.286 | 0.321 |

The NPS samples exhibit a high available surface area for an average pore size of less than 2 nm (Table 1), well below the critical pore radius of 2.2 nm for

water adsorption at room temperature [24]. A key aspect of reversibility between the adsorption and desorption curves for the porous material is the pore size distribution. The sponges exhibit a very narrow pore size distribution (FIG. 5), preferential for reversibility.

At first sight, the different treatment applied on the NPS samples in terms of N and O addition seem to have only little effect on the porosity. However, FIG. 5 shows that a larger proportion of pores with a size greater than 2.2 nm are present with samples containing N.

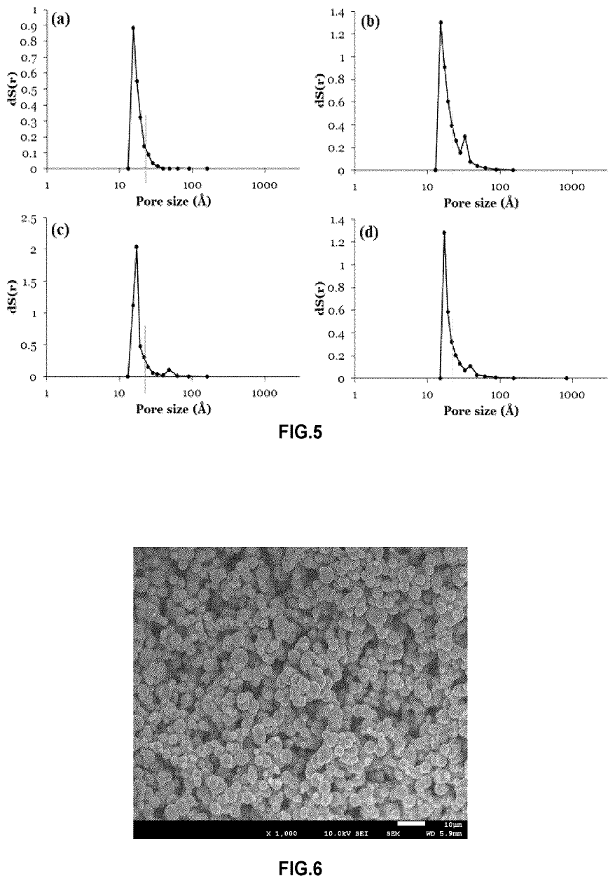

The micrometric structure of the non-functionalized NPS is shown on FIG. 6. The NPS have a spherical shape with a mean diameter of 3.7±1.1 μm. The micro-particles may have this specific shape due to the synthesis process where

resorcinol and formaldehyde are polymerized in diluted conditions or may be obtained following grinding of larger particles. The micro-particles then agglomerate through the complete evaporation of the solvent and maintain their shape through the heat treatments.

### Chemical Composition

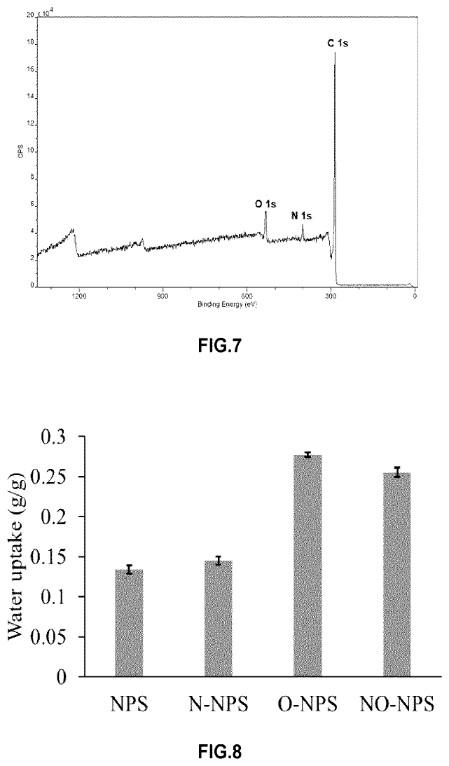

A typical XPS survey is shown on FIG. 7 with the corresponding peaks of carbon C 1s, nitrogen N 1s and oxygen O 1s. The concentration for the four NPS samples is summarized on Table 2.

TABLE 2
Summary of the carbon, oxygen and nitrogen
surface concentration on the NPS

| | C1s (at %) | O1s (at %) | N1s (at %) |
|---|---|---|---|
| NPS | 93.8 | 6.2 | — |
| N—NPS | 92.0 | 5.1 | 2.9 |
| O—NPS | 93.0 | 7.0 | — |
| NO—NPS | 88.5 | 7.1 | 4.4 |

XPS results show that N is effectively added to the material structure and remains present even after the pyrolysis step. O concentration is slightly increased after the oxidation step. One can note the increase of N concentration when the oxidation step is performed for NO-NPS, explained by mass loss observed during the heat treatments. Indeed, an 80% mass loss is observed after the pyrolysis step while an additional 60% of mass loss from the remaining material is observed after the oxidation step. Phenanthroline having the ability to incorporate to a carbon matrix during pyrolysis [26], one can expect N concentration to increase after the oxidation step. The deconvolution of carbon C1s peak shows that the majority of C is graphitized through pyrolysis with more than 80% of C in the sp² configuration.

The elemental composition of the bulk of the sponges is done on a CHN analyzer. The resulting weight concentrations are then converted into atomic concentrations in order to allow the comparison with the surface composition (Table 3). Overall, the amount of O is greater on the surface rather than the bulk of the samples, because the oxidation process is a surface phenomenon. The concentration of N is similar in the bulk and on the surface, in agreement with the addition method of phenanthroline. Indeed, the molecule is initially mixed with the other compounds and is supposed to be fully incorporated in the solid.

TABLE 3
Elemental composition of the NPS samples bulk.

| | Carbon | Oxygen | Nitrogen |
|---|---|---|---|
| | (at %) | (at %) | (at %) |
| NPS | 99.2 | 0.8 | — |
| N—NPS | 96.6 | 1.1 | 2.3 |
| O—NPS | 97.7 | 2.3 | — |
| NO—NPS | 86.0 | 9.7 | 4.3 |

### NPS Water Uptake in Environmental Chamber

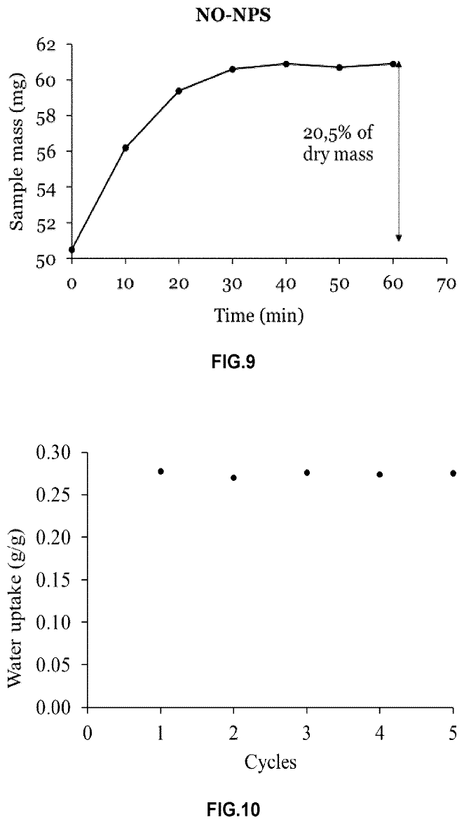

The oxidation step seems to play an important role in the increase of the water uptake between the different samples (FIG. 8). The material almost doubles its water capture capacity after undergoing the oxidation, and almost reaches the total pore volume measured by BET analysis. At 90% RH, N addition does not appear to have a significant effect on the water uptake. Pyrolysis under CO₂ at higher temperature of the unground RF resin leads to improved water uptake (0.188 g/g at 60% RH, 0.211 g/g at 95% RH), though water uptake is significantly improved if the RF resin is ground prior to CO₂ pyrolysis (0.144 g/g at 60% RH, 0.412 g/g at 95% RH). As the application of water harvesting adsorbents are particularly pertinent at low RH, the two best performing samples have been tested at 40% RH. Under these conditions, O-NPS and NO-NPS show a respective water uptake of 0.14 and 0.21 g/g of NPS. At this RH, the addition of N functionalities seems to improve the overall water uptake. The adsorption kinetics at 40% RH are slower and it takes nearly 40 min to reach a plateau compared to 10 min at 90% RH (FIG. 9).

### NPS Cyclability

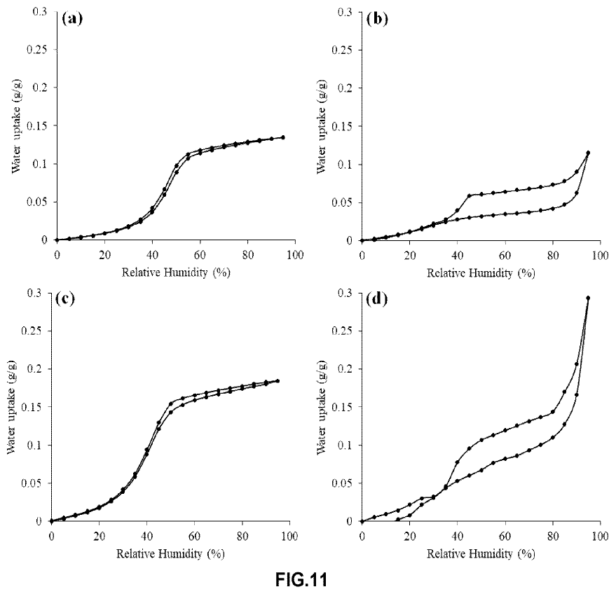

An important aspect of using NPS to capture atmospheric water is the cyclability of the material, meaning keeping constant performance over adsorption and desorption cycles. We tested successive cycles of adsorption in the environmental chamber and desorption in the oven while recording the water uptake at each cycle (FIG. 10 shows the O-NPS cyclability). Complete de-sorption at 150° C. for 1 h was achieved between each adsorption test. After 61 cycles, there are no significant loss of performance, phenomenon that can be observed for several MOFs adsorbents [11]. Small variations between each cycles can be attributed to the powder manipulation between each of the adsorption and desorption phases.

### Adsorption Isotherms and Theoretical Aspects

The isotherms have been obtained with DVS for the four samples (FIG. 11) to characterize water uptake over the full range of RH as well as the hysteresis between the adsorption and desorption. NPS and O-NPS have a type V isotherm (IUPAC classification) with little to no hysteresis while N-NPS and NO-NPS have a type VI isotherm with a H3 hysteresis loop. This type of hysteresis loop is generally associated with non-rigid aggregates of plate-like particles [27], [28]. From these isotherms, it seems that the presence of O in the material increases the overall water uptake. This result was already observed in the environmental chamber and comes from a high affinity between water molecules and O functionalities. N has a more com-plex role since the water adsorption happens at higher RH and the isotherms present a stronger hysteresis. One can note that the samples had higher water uptakes when measured in environmental chamber compared to the isotherms, except for the non-functionalized NPS. This difference may be due to several reasons including: (a) RH error in the environmental chamber (±2%) that would affect particularly the samples containing N, (b) potential sources of errors leading to over-estimation of the water uptake in the environmental chamber and (c) an inhomogeneity of the functionalized materials knowing that DVS measures samples less than 1 mg.

Fitting the experimental data with the DDN model led to determination coefficient higher than 0.99. The error on the different parameters was determined from several combinations of fitting parameters leading to a R² higher than 0.99 (Table 4).

TABLE 4
Fitting parameters of the DDN model to the water adsorption isotherms.

| | | | Maximum | | | | |
|---|---|---|---|---|---|---|---|
| | Surface | Micropore | water | | | | |
| | active site | saturation | molecules | Water | Chemisorption | Micropore | |
| | concentration | concentration | per | cluster | equilibrium | equilibrium | |
| | aₒ | a_{μs} | surface | size | constant | constant | |
| | (mmol/g) | (mmol/g) | site N | nm | K_{f} | K_{μ} | R² |
| NPS | 0.42 ± 0.03 | 5.43 ± 0.19 | 11 ± 1 | 9 ± 0 | 15 ± 1 | 1072 ± 64 | 0.992 ± 0.002 |
| N- | 0.25 ± 0.01 | 1.26 ± 0.05 | 172 ± 1 | 5 ± 0 | 15 ± 1 | 687 ± 8 | 0.992 ± 0.001 |
| NPS | | | | | | | |
| O- | 0.65 ± 0.03 | 7.77 ± 0.30 | 8 ± 0 | 7 ± 0 | 16 ± 3 | 570 ± 42 | 0.993 ± 0.002 |
| NPS | | | | | | | |
| NO- | 0.65 ± 0.03 | 3.02 ± 0.24 | 155 ± 3 | 6 ± 1 | 16 ± 2 | 703 ± 33 | 0.993 ± 0.002 |
| NPS | | | | | | | |

The presence of O in the sample increases the parameters ao and aps while the addition of N in the NPS drastically changes the N parameter value. All of these parameters are in the range of physical meaning [29] and can help resolve fundamental differences between the structures. Table 5 summarizes the absolute concentration of functional groups from the de-convolution of high-resolution peaks of O and N. It shows a close correlation between the concentration of hydroxyl (OH) groups and the parameter a₀ that corresponds to the primary ad-sorption sites. It suggests that OH groups are solely responsible of the first water molecules adsorbing on the NPS samples through hydrogen bonding, while N actually decreases the concentration of OH. The parameter a_{μs} corresponds to the micropore filling concentration. Micropores typically have a size below 2 nm. NPS and O-NPS have 75-80% of their pores in this region while it is only 55% for N-NPS and NO-NPS. Micropore saturation concentration a_{μs} is lower than expected values following earlier observation between the DVS and environmental chamber measurements.

TABLE 5
Absolute concentration of species on NPS surface al deconvolution
of high-resolution XPS carbon C1s peak for non-functionalized
NPS sample, converted from at % to mmol/g.

| | | | | N | | | |
|---|---|---|---|---|---|---|---|
| | | | | pyri- | N | N | |
| | O═C | O—C | C—OH | dinic | pyrolic | quat | N—O |
| | (mmol/ | (mmol/ | (mmol/ | (mmol/ | (mmol/ | (mmol/ | (mmol/ |
| | g) | g) | g) | g) | g) | g) | g) |
| NPS | 2.21 | 1.34 | 0.60 | — | — | — | — |
| N-NPS | 2.00 | 1.93 | 0.20 | 0.89 | 0.62 | 0.73 | 0.16 |
| O-NPS | 2.38 | 2.67 | 0.66 | — | — | — | — |
| NO- | 2.67 | 2.51 | 0.54 | 1.35 | 0.90 | 1.12 | 0.23 |
| NPS | | | | | | | |

The water cluster size m that fills the micropores has little difference between the samples, contrary to N, the maximum number of water molecules attached to a primary adsorption site. The presence of N increases the parameter value from μ10 molecules to more than 150. At low RH, the first adsorption steps are described as: (i) a first water molecule attaches to the primary ad-sorption site through hydrogen bonding (ii) water molecules turn into secondary adsorption sites (iii) additional water molecules adsorbed to the secondary adsorption sites until reaching the maximum average value N [22]. N-containing samples had lower OH concentration that were identifies as the primary adsorption sites as well as lower micro-porosity. One can suppose that the maximum N value is driven by physical blockage, i.e. pore size as well as interaction with other water clusters. Large water clusters with size up to 280 molecules are de-scribed by Ludwig et al. [30]. No clear tendencies can be drawn from the equilibrium constants K_{f} and K_{μ}respectively correlated to chemisorption and micropore filling.

### Scalability of the NPS

A larger batch of non-functionalized NPS has been synthesized to verify the scalability of the NPS synthesis process and verify that the observed performance is maintained at larger scale. While smaller samples of RF resin before pyrolysis were easily turned under a powder form, larger scale showed a compact and glassy material that had to be crushed and powdered before heat treatment. Pyrolysis lead to smaller mass loss under these larger scale conditions, passing from 80% to 50%, probably due to the higher particle size since the composition remained identical.

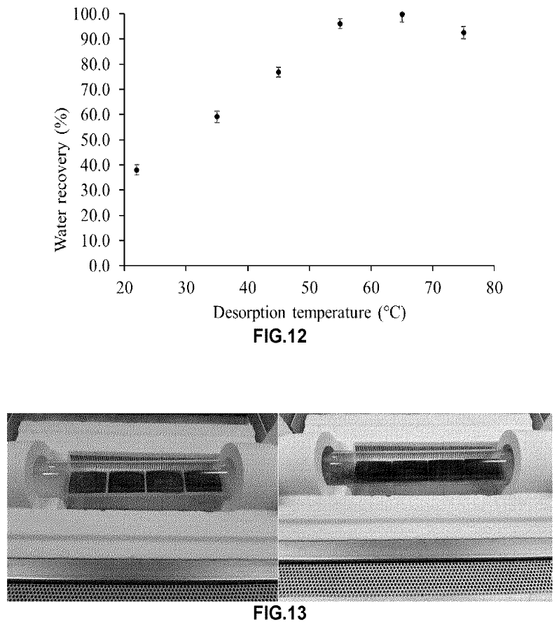

The resulting non-functionalized NPS weighed 30 g, compared to the 30 to 200 mg tested in the environmental chamber and less than 1 mg in the DVS. This batch was tested in a water capture set-up (described below) and water collected from condenser was weighed as a function of the desorption temperature (FIG. 12). Some water remained stuck in the water-cooled condenser and the collected water weight was corrected to take it into account, by assuming a constant mass of 1.5±0.1 g of water stuck on the condenser walls. Water uptakes between 0.14 and 0.16 g/g were measured and are very close to those observed at small scale.

The optimum range for the desorption temperature was found between 55° C. and 75° C. from these tests. However, measurement of the mass before and after desorption showed that no water was left in the NPS material even at room temperature, which is in agreement with the absence of hysteresis from the adsorption isotherms. At this moment, the lower water recovery observed at reduced temperature may be due to the set-up itself rather than the material. Lower temperatures generate less supersaturated vapor from the NPS leading to smaller condensation rates.

### Discussion

Water adsorption performance of our NPS is compared to other adsorbents (Table 6), including MOFs, zeolites, mesoporous silica and carbon-based adsorbents. This comparison focuses mainly on relevant parameters for large-scale application. The water uptake loss after 5 cycles provides insight on the stability of the material over adsorption and desorption cycles. Results for the nanoporous of the present application have demonstrated constant adsorption uptake after over 60 cycles. Practical application requires thousands of cycles and thus require minimal loss from one cycle to the other. The desorption temperature corresponds to the temperature required to regenerate the material before a new adsorption cycle and is related to the amount of energy required to extract water from the adsorbent. Some recent studies show techniques to relate on solar irradiation through day and night cycles [31]. Cold and humid nights allow for efficient water adsorption while sun warmth during the day provokes water desorption. However, this system limits to a single adsorption and desorption cycle per 24 hours period. More daily cycles would require energy input for desorption, and thus the lowest regeneration temperature is recommended. One should note that vacuum is often applied in previous literature to force water desorption while our NPS samples were desorbed at ambient pressure.

TABLE 6
Comparison of water uptake at low and high relative humidity, cyclability
and desorption temperature of common adsorbent from literature

| | | | Desorption | Water uptake | |
|---|---|---|---|---|---|
| Name of | Water uptake | Water uptake | temperature | loss after 5 | |
| adsorbent | at RH = 30% | at RH = 90% | (° C.) | cycles (%) | Reference |
| Basolite A100 | 0.06 | 0.25 | 96 | 36 | [32], [33] |
| MCM-41 | 0.06 | 0.96 | 225 | 4.2 | [32] |
| Nanoporous | 0.14 | 0.28 | 55 | 0 | This work |
| sponges | [40% RH] | | | | |
| (Cr)MIL-101 | 0.15 | 1.35 | 140 | 0 | [11] |
| Basolite A300 | 0.26 | 0.82 | No available | 65.6 | [32] |
| | | | data | | |
| PCC-1 | 0.26 | 0.33 | 100 | 0 | [13] |
| MOF-801 | 0.27 | 0.35 | 80-85 | 5.5 | [32], [34] |
| CAU-10 | 0.28 | 0.37 | 75 | 0.8 | [32], [35] |
| CAU-6 | 0.34 | 0.38 | 150 | 40.8 | [32], [36] |
| Zeolite 13X | 0.39 | 0.42 | 150 | 63.9 | [32], [37] |
| Basolite C300 | 0.52 | 0.69 | 102 | 68.1 | [32], [38] |
| Ni-MOF-74 | 0.55 | 0.62 | No available | 52 | [32] |
| | | | data | | |
| Co-MOF-74 | 0.57 | 0.63 | No available | 37.6 | [32] |
| | | | data | | |
| Mg-MOF-74 | 0.61 | 0.75 | 75 | 57.3 | [32], [39] |

From Table 6, NPS water uptake at low and high relative humidity is lower than reported adsorbent from literature. However, most adsorbents have low stability over 5 adsorption and desorption cycles as well as high desorption temperature. This can be explained by hydrolytic stability, where the adsorbent structure is affected by the presence of water. It is particularly pertinent for MOF structure where the metallic and organic constituents are in coordination with each other, while carbon bonds are present in the NPS as well as the porous carbon cuboids (PCC-1) [13]. From the established list, MOF-801, CAU-10, PCC-1 and our NPS follow the required criteria of low desorption temperature and stability over regeneration cycles. One of the main advantages of the MOFs is the high control in the pore size due to a large selection of molecular components of various nature and size. In contrast, NPS porosity is inherent to the material with limited control at this point.

Adsorption kinetics have not been included in Table 6. The reason for such omission is the challenging comparison of kinetics from one literature study to the other. Rigorous and identical experimental conditions are required to set a comparison basis. Kinetics are highly dependent on pressure and temperature conditions, RH, humid air flow rate as well as the way the adsorbent gets in contact with humid air (diffusion or feedthrough) [40], [41].

An important aspect for water adsorption at an industrial level is the ability to synthesize adsorbent at large scale. The NPS synthesis process is relatively simple and was already scaled to tens of grams in laboratory. A full-scale installation could readily deliver kilograms to tons of adsorbents, as pyrolysis is a well-established industrial process. The main primary constituents of NPS are an organic compound, such as resorcinol, and formaldehyde, which are abundant and low-cost chemicals, with respective prices of 1,700 US$ [42] and 500 US$ [43] per ton. Taking into account the base materials, solvent, and energy requirement for NPS synthesis, it is estimated that NPS material would cost from 15 to 40 US$ per kg. On the other hand, MOFs face challenges in their scalability. MOF crystallization is a slow process with highly controlled temperature and pressure conditions in batch process. For example, Furukawa et al. described a 6-hour long synthesis for 10 g of MOF-801 followed by a 7-day period of rinsing and drying the material [32]. On top of a slow synthesis process, MOF precursors can be expensive, especially because of their metallic content. As a result, MOF-801 is commercially available at 100,000$US per kg [44]. One can note that new synthesis processes are developed to help the scalability of MOFs such as electrochemistry or assistance with microwaves [45].

### Conclusion

Nanoporous sponges based on resorcinol-formaldehyde resins were prepared undergoing heat treatments and functionalization steps, NPS, N-NPS, O-NPS and NO-NPS. These adsorbents possess a fine and narrow pore size centered around 1.5 nm. They exhibited good performance for water adsorption, especially O-NPS, having a water uptake of 0.28 g/g of adsorbent at 90% RH and 0.14 g/g at 40% RH, stable over five regeneration cycles. The scalability of the material has been demonstrated, maintaining their performance from the tens of milligrams to the tens of grams scale. The fitting of adsorption isotherms with Do & Do theoretical model highlighted the role of the hydroxyl groups as primary adsorption sites. Oxygen addition had the tendency to improve the OH concentration and thus improve the water adsorption performance. On the opposite, nitrogen addition reduced the OH groups concentration and modified the porosity itself of the material, resulting in the presence of a H3 hysteresis in the isotherms. Improvement perspectives for the NPS adsorbents include a better control of the OH groups during the synthesis process. Heat and mass transfer of water vapor through the NPS micro particles, as well as inside the pores will need to be taken into account.

### Example 2

NPS synthesis

The nanoporous sponges (NPS) synthesis protocol is recalled here. The NPS consist of resorcinol-formaldehyde resin that undergoes different treatments. The resin is first synthesized through wet chemistry, where resorcinol (benzene molecule with two hydroxyl groups), formaldehyde and a catalyst (sodium carbonate) are dissolved in a solvent consisting of a 1:1 mixture of water and ethanol. By heating this mixture at 80° C. during 24 h, resorcinol and formaldehyde polymerize into a porous matrix and the solvent is evaporated.

This matrix is then pyrolyzed (heated in the absence of oxygen) to carbonize the resin, as seen on FIG. 13, causing a shrinkage of the pores to the required size. A molecule containing nitrogen functional groups, phenanthroline, can also be added to the initial mixture, and an oxidation step can further be carried out at the end of the synthesis process. The purpose of these two steps is to add functional groups to the porous matrix and capture water more easily.

Tests and characterization, as described in Example 1, were mostly done on small scale samples up to ˜100 mg, while preliminary confirmation validated that a batch of 30 g had similar properties. It is important to note a difference in the synthesis process between “small” and “large” batches of the NPS. In the small batch, the precursors were highly diluted with a concentration of approximately 0.02 g/mL of solvent solution. The cured resin after solvent evaporation was highly crumbly and easily put under the form of a powder with slight manual crushing. For the synthesis of the larger batch, such dilution ratio was not applied due to the large volumes of solvent to evaporate. As such, higher precursor concentrations of 0.3 g/mL were used. The resulting cured resin was a hard and brittle block that required higher effort to transform into powder with a pestle and mortar. The obtained powder was rough and finer powder could be obtained with grinders and ball milling techniques.

### Physical Characterization

The two techniques employed here to complete the already performed characterizations on the NPS are Scanning Electron Microscopy (SEM) and Dynamic Vapor Sorption (DVS). The NPS samples were analyzed by SEM using a JEOL 7600TFE instrument, operated at 10 kV, as well as a Hitachi S-4700 instrument at 3 kV, in order to observe structural differences depending on the synthesis conditions and functionalization.

Dynamic vapour sorption (DVS) is a gravimetric analysis technique that determines sorption properties by measuring sample mass continuously, directly giving the rates of adsorption and desorption. A DVS system consists of a temperature- and humidity-controlled chamber, and a quartz microbalance inside the chamber upon which the sample is placed. The microbalance records sample mass continuously and the DVS system can be used either to simply measure sorption properties at a given set point or determine adsorption/desorption isotherms by varying the relative humidity in pre-determined steps. The adsorption isotherms were obtained on a DVS Intrinsic instrument from Surface Measurement Systems Ltd., UK.

### Environmental Chamber

Due to a low availability and high maintenance time of existing DVS equipment, the environmental chamber was adapted into a fully automated gravimetric equipment. The temperature is controlled with an electrical heater that allows the chamber to go from room temperature to 38° C. Relative humidity (RH) is controlled with a commercial ultra-sonic humidifier when RH has to be increased and a normally closed solenoid valve on a dry air line when RH has to be decreased. A fan is mixing homogeneously the air in the chamber. An Arduino Uno and relay control the power inputs of heater, humidifier, solenoid valve and fan with simple on/off switches. Arduino and Python codes on the laptop enable the full automation of a given procedure that can run for several days. NPS powder sample (˜5 g) is placed in a large glass dish suspended under a balance that records the sample mass in real time. As such, temperature, relative humidity and mass are collected and analyzed to determine the isotherm, kinetics and cyclability of a given sample. For isotherms, the RH is varied from 5 to 95% with 5% steps at constant temperature and letting mass equilibrate between each step. Kinetics can be studied by abruptly switching from one RH value to another one and record the time to equilibrate the mass. Cyclability is verified by reproducing the same variations from one RH value to another one over and over.

### Desorption Study in Water Capture Device

The water adsorption properties of non-functionalized NPS measured with small scale (<100 mg) samples were validated on a larger scale with a custom-made water capture set-up: Moist air is generated by a boiler and passed through the porous material at a controlled flow rate, until saturation occurs. The NPS is contained in a column insulated with glass wool. Desorption is accomplished through mild heating with a heating tape coiled around the column to release the water. Desorbed steam is then condensed with a water-cooled condenser. This device can accommodate tens of grams of NPS, and can quite accurately measure the amount of water collected per adsorption/desorption cycle.

It is important to note that some desorbed water was always remaining on the condenser walls. The amount of irretrievable water from the condenser was estimated based on the main assumption that the condenser has the same amount of water left on the inner walls after each experiment. This assumption is reasonable since water saturates the condenser walls before droplets fall down in the beaker. This saturation was assumed to be constant with 5% error. The 30 g of tested NPS were able to adsorb 4.5 g of water at 90% RH. At 60° C., all of the water was desorbed from the NPS as their weight was measured after desorption, and only 3.0 g of water was retrieved in the beaker. As a result, it was assumed that 1.5±0.1 g of water remains attached to the condenser walls during the different measurements.

### Theoretical Models

### DDN Model

As described in Example 1, the experimentally-determined adsorption isotherms have been fitted to the theoretical equation of Do and Do, modified by

Neitsch et al (DDN) [20]-[23]. This equation describes the adsorption process of H₂O on C as a two-step mechanism, where the first step corresponds to adsorption of water molecules on primary sites (functional groups) on the surface. Water clusters then grow around these primary sites via hydrogen bonds. The second step occurs when clusters reach a threshold size of 6 molecules and break down into water pentamers that fill the micropores. It has been shown by Neitsch et al. that pentamers can be generalized into m-mers for higher accuracy [21]. The equation describing water adsorption is:

$$a = {a}_{0} \frac{{K}_{f} {\sum }_{n = 1}^{N} n {h}^{n}}{1 + {K}_{f} {\sum }_{n = 1}^{N} {h}^{n}} + {a}_{μ s} \frac{{K}_{μ} {h}^{m}}{1 + {K}_{μ} {h}^{m}} \qquad ( Equation 1 )$$

where a is water uptake, a₀ is the concentration of surface active sites, a_{μs} is the saturation concentration in the micropores (all three in units of mol/g); K_{f} is the chemisorption equilibrium constant, K_{μ} is the micropore equilibrium constant; N is the maximum number of water molecules adsorbed per surface site; m is the size of the water m-mers that desorb from clusters and fill the micropores; and h is the relative pressure. To fit experimental data with the theoretical equation, we used the least-square method with the determination coefficient R², as follows:

$${R}^{2} = 1 \frac{\sum {( {a}_{e x p} - {a}_{t h} )}^{2}}{\sum {( {a}_{e x p} - \overline{{a}_{e x p}} )}^{2}} \qquad ( Equation 2 )$$

where aₑₓₚ represents experimental data, aₜₕ the corresponding theoretical data, and a̅ₑ̅ₓ̅ₚ̅ the average of experimental data over the relative pressure range.

### Kinetics of Intra-Particle Diffusion

The kinetics of adsorption are studied experimentally and can be modelled for spherical particles of known radius thanks to Fick's law of diffusion (Equation 3) (see Kim et al [46]).

$$\frac{\partial C}{\partial t} = \frac{1}{{r}_{c}^{2}} \frac{\partial }{\partial r} ( {D}_{μ} {r}_{c}^{2} \frac{\partial C}{\partial r} ) \qquad ( Equation 3 )$$

where C is the water vapor concentration, r_{c} is the particle radius, and D_{μ} is the intra-particle diffusion coefficient. A mathematical solution to Fick's law of diffusion has been established by Kim et al. in order to take into account fitting of actual gravimetric data (Equation 4) [46].

$$\frac{{m}_{t}}{{m}_{eq}} = 1 - \frac{6}{{π}^{2}} {\sum }_{n = 1}^{∞} ( \frac{1}{{n}^{2}} ) {e}^{( - \frac{{n}^{2} {π}^{2} {D}_{u} t}{{r}_{c}^{2}} )} \qquad ( Equation 4 )$$

where mt/me q refers to the fractional water uptake (FWU), a gravimetric parameter describing adsorption, and being equal to 0 at t=0s, and equal to 1 once the equilibrium water uptake has been reached. The intra-particle diffusion coefficient can be determined over a range of relative humidity and temperature, based on DVS data. Once determined, a simple kinetics profile based on the linear driving force model

(Equation 5) can predict the adsorption or desorption rate over the time [47]. The solution to the linear driving force model is provided in Equation 6.

$$\frac{\partial {C}_{μ}}{\partial t} = \frac{15}{{r}_{c}^{2}} {D}_{μ} ( {C}_{e q} - {C}_{μ} ) \qquad ( Equation 5 )$$

where C_{μ} is the instantaneous vapor concentration in the particle, and C_{eq} is the equilibrium vapor concentration.

f(t)=1−e^{-k}^{_{L}}^{t} (Equation 6)

where f(t) corresponds to the FWU previously defined and k_{L}=15 Dμ/rc2. The particle radius size is extracted from the electron microscopy data.

### Mass and Energy Transport in Packed Adsorbent

While the isotherms provide resourceful and fundamental information on the developed adsorbents, it is important to predict how the fundamental properties can translate into design parameters in an industrial scaled equipment. As such, a

model described with high details by Kim et al [47] and summarized here is applied and solved in the present case. It consists of the equations of mass and energy transport in a packed adsorbent layer of known thickness (Equations 7 and 8). This model takes into account the water vapour diffusion between the particle (inter-particle diffusion) and the ability of the particles to adsorb and retain water (intra-particle diffusion). The equations are solved by finite differences technique.

$$\frac{\partial C}{\partial t} = ∇ \cdot {D}_{v} ∇ C - \frac{( 1 - ε}{ε} \frac{\partial {C}_{μ}}{\partial t} \qquad ( Equation 7 )$$

$$ρ {c}_{p} \frac{\partial T}{\partial t} = ∇ \cdot k ∇ T + {h}_{ad} ( 1 - ε ) \frac{\partial {C}_{μ}}{\partial t} \qquad ( Equation 8 )$$

where C is the water vapor in air concentration in the packed adsorbent layer [mol/m3], T is the temperature in the packed adsorbent [K], Dᵥ is the inter-particle diffusion coefficient, E is the packed porosity, ∂C_{μ}/∂t is the adsorption/desorption rate provided by the gravimetric data [mol/m³·s], ρ is the locally averaged density, cₚ is the specific heat capacity of the adsorbent [J/K·kg], k is the thermal conductivity [W/m·K] and had is the enthalpy of adsorption [J/mol].

The specific heat capacity and thermal conductivity are estimated for the moment based on the values for carbon material, and powder samples at 750 J/K·kg and 0.1 W/m·K. It is planned to measure experimentally these values. The enthalpy of adsorption can be determined from thermodynamic model based on isotherms recorded for at least three different temperatures. The packed porosity is measured experimentally following the formula given by Equation 9.

$$E = 1 - \frac{{ρ}_{ads}}{{ρ}_{powder}} \qquad ( Equation 9 )$$

where ρ_{ads} is the apparent density of the adsorption layer and ρ_{powder} is the density of the powder itself. ρ_{ads} can be easily determined by weighing a known volume of adsorbent. ρ_{powder} requires to fill the void volume between the particle with a known volume of water, before weighing the mixture water-powder and measuring its volume. It can be noted that the minimum packing porosity for spherical particles is obtained for hexagonal closed-packed configuration and equal to 0.25.

The inter-particle diffusion coefficient Dᵥ is given in Equation 10.

$${D}_{v} = {{ε}^{3 / 2} ( \frac{1}{{D}_{vap}} + \frac{1}{{D}_{K}} )}^{- 1} \qquad ( Equation 10 )$$

where Dᵥₐₚ is the water vapor molecular diffusivity in air, and equal to 2.82·10−5 m²/s at 298 K, and D_{K} is the Knudsen diffusion coefficient [m²/s], typical of tight spaces
where the collision between the water molecules and the material walls are frequent. The Knudsen diffusion coefficient relation is given in Equation 11.

$${D}_{K} = \frac{{d}_{p}}{3} \sqrt{\frac{8 RT}{π M}} \qquad ( Equation 11 )$$

where dₚ is the characteristic void size [m], or the average distance between two particles in other terms, R is the gas constant [m³·atm/mol·K], T is the temperature [K], M is the molecular mass of vapor [kg/mol]. The characteristic void size is obtained based on a probability distribution that depend on the packing porosity, and given in Equation 12.

$$( Equation 12 )$$

$$P ( χ ) = 3 {( 1 + χ )}^{2} \frac{ε ( 1 - ε ) ( 1 - {ε}_{HCP} )}{( ε - {ε}_{HCP} )} {e}^{( - \frac{( 1 - ε ) ( 1 - {ε}_{HCP} )}{( ε - {ε}_{HCP} )} [ {( 1 + χ )}^{3} - 1 ] )}$$

where ε_{HCP} is the packing porosity of hexagonal closed-packed configuration (0.25). The characteristic void size is calculated from Equation 13:

dₚ=2r_{c}Xₐᵥ (Equation 13)

where ε_{HCP} is the particle radius [m] and Xₐᵥ is calculated from the probability distribution in Equation 14:

$${χ}_{av} = \frac{1}{ε} {\int }_{0}^{∞} χ P ( χ ) d χ \qquad ( Equation 14 )$$

### Results

### NPS Morphology

The micrometric structure of non-functionalized NPS, shown on FIG. 6, reveals spherically shaped particles with a mean diameter of 3.7±1.1 μm. These micro-particles are thought to have this specific shape on account of the synthesis

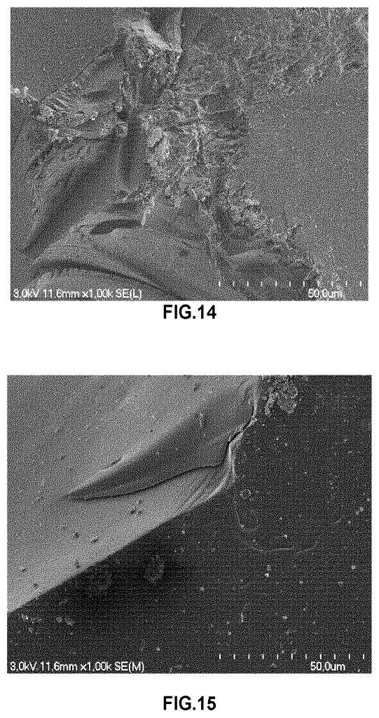

process, whereby resorcinol and formaldehyde are polymerized in dilute solutions [25]. The micro-particles agglomerate through complete evaporation of the solvent, and they maintain their shape in the course of heat treatments. These spherical micro-spheres are observed when the precursors are diluted in the water/ethanol solvents (concentrations lower than 0.1 mol/L). When synthesizing larger batches of NPS samples, the precursors have been more concentrated in order to decrease the solvent volume to evaporate, with precursor concentrations around 1 mol/L. The spherical microstructure was not observed anymore (FIG. 14). The synthesis under concentrated conditions lead to large macrometric blocks (FIG. 15) that were crushed into finer powder.

### Desorption of the NPS in the Water Capture Device

A larger batch of non-functionalized NPS was synthesized in order to verify whether the NPS synthesis process could readily be scaled up, and the observed performance maintained. While smaller samples of RF resin were easily turned into powder before pyrolysis, larger batches formed a compact, glassy material that had to be crushed into powder before heat treatment. Pyrolysis of the latter led to smaller mass loss, going from 80% to 50%, probably due to the larger particle size since the composition remained identical.

The resulting scaled-up batch of non-functionalized NPS weighed 30 g, compared with 30 to 200 mg batches tested in the environmental chamber, and less than 1 mg in the DVS. This larger batch was tested in the water capture device and desorbed water collected from the condenser was weighed as a function of time, depending on the desorption temperature (FIG. 12). Some water remained adhering to the walls of the water-cooled condenser. The weight of collected water was corrected to take this into account, by assuming a constant mass, 1.5±0.1 g, of irretrievable water on the condenser walls. Water uptakes were found to be between 0.14 and 0.16 g/g, very close to those observed at small scale.

Based on these tests, the optimum desorption temperature was found to range between 55° C. and 75° C. The water recovery rates have to be taken with caution due to the water left on the condenser walls. Mass measurements before and after desorption showed no residual water in the NPS material, even at room temperature, in agreement with the observed non-hysteretic adsorption isotherms. Without being bound to theory, it is believed that the lower percentage of water recovery at reduced temperature in FIG. 12 may be due to the experimental set-up itself rather than a material intrinsic property. Lower temperatures could reduce the desorption kinetics of the NPS, generating less concentrated water vapor in air, making the vapor liquefaction by the water-cooled condenser less efficient. As a result, for the same amount of desorbed water, less water would be condensed at lower temperature.

### NPS Isotherms

Isotherms of the four sample types were obtained with the DVS instrumentation (FIG. 11), to characterize water uptake from 0 to 95% RH, along with hysteresis between the adsorption and desorption portions. NPS and O-N PS are seen to display a type V isotherm (IUPAC classification) with little to no hysteresis, while N-NPS and NO-NPS have type VI isotherms with a H3 hysteresis loop. This type of loop is generally associated with non-rigid aggregates of plate (oblate spheroid)-like particles [27], [28]. On a practical aspect, it means that NPS and O-NPS will adsorb most of the water at low RH (40-60% RH) while N-NPS and NO-NPS require high RH to reach their maximum water uptake, which can have interest in high humidity environments. On top of that, the higher hysteresis for N-NPS and NO-NPS can be related to a higher energy requirement for desorbing water.

From these isotherms, it appears that O in the material increases overall water uptake, a result already observed with the environmental chamber and resulting from affinity between water molecules and highly polar O functionalities (attractive dipole-dipole interactions, hydrogen bonding). On the other hand, N seems to have a more complex role since water adsorption occurs at higher RH and the isotherm presents stronger hysteresis. One can also note that samples had higher water uptake values when measured in the environmental chamber, except for the case of non-functionalized NPS. Reasons for this difference may include RH error in the environmental chamber (±2%) that would particularly affect samples containing N. Indeed, at 90% RH, a small variation of RH will lead to a greater variation of water uptake for the N-functionalized NPS compared to the others. Other causes for this difference include potential over-estimation of water uptake in the environmental chamber, and inhomogeneity of the functionalized materials, knowing that sample mass of less than 1 mg are analyzed with DVS.

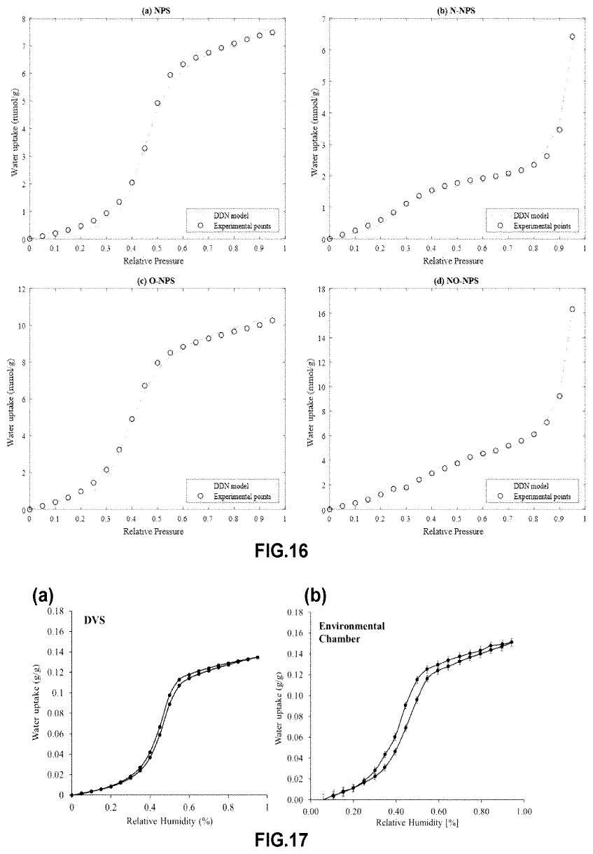

Fitting the experimental data with the DDN model resulted in a strong mathematic fit, namely R²>0.99, as seen on FIG. 16. The error on the different parameters was determined from several combinations of fitting parameters leading to the mentioned R² values higher than 0.99 (see Table 4 above, Example 1).

The presence of bonded O in a sample is seen to increase the values of parameters a₀ and a_{μs}, while that of N in the NPS drastically changes the N parameter's value. All of these parameters are in ranges that possess plausible physical meanings

[29], and this fact can help resolve observed fundamental differences between the various structures. Table 5 in Example 1 summarizes the absolute concentrations of diverse functional groups, obtained by deconvoluting high-resolution XPS peaks of O 1s and N 1s. It shows a close correlation between the concentration of hydroxyl (OH) groups and the parameter a₀ that corresponds to the primary adsorption sites. This strongly suggests that OH groups are responsible as adsorption sites for the first water molecules, via hydrogen bonding; in contrast, the presence of N is seen to actually decrease the concentration of OH. The parameter a_{μs} corresponds to the micropore filling concentration; micropores typically have sizes below 2 nm. NPS and O-NPS have 75-80% of their pores in this size range, while it is only 55% for N-NPS and NO-NPS. Micropore saturation concentration a_{μs} is lower than expected for N-NPS, O-NPS and NO-NPS, when compared to the values obtained in the environmental chamber. This observation fits with the abovementioned discrepancy between the DVS and environmental chamber measurements.

The water cluster size m that can fill the micropores differs little between the samples, contrary to N, the maximum number of water molecules that can attach to a primary adsorption site. The presence of N increases this parameter value from N ˜10 molecules to more than 150. At low RH, the initial adsorption steps can be described as follows: (i) a first water molecule attaches to the primary adsorption site through hydrogen bonding; (ii) subsequent water molecules become secondary adsorption sites; (iii) additional water molecules adsorb onto the secondary adsorption sites until reaching the maximum value N [22]. In Table 5, it can be observed that the N-containing samples have lower OH concentration. A lower concentration of hydroxyls, thus a reduced number of primary adsorption sites, allows for more physical space around each site enabling a larger amount of water molecules to be attached. This is also reflected in the observation of larger pores for N-containing samples. One can suppose that the maximum N value results from physical blockage, governed by pore size as well as interaction with other water clusters. Indeed, large water clusters with sizes up to 280 molecules have been reported by Ludwig et al. [30]. No clear tendencies can be drawn from the equilibrium constants Kf and Kμ, respectively correlated to chemisorption and micropore filling.

Isotherms for NPS are also obtained in the environmental chamber, that are further discussed in the next section. A comparison of the isotherms between the DVS, done on a small batch and the environmental chamber, on a larger batch of NPS is shown in FIG. 17. This comparison offers the validation of the environmental chamber compared to an actual DVS equipment while supporting the scalability of the NPS. One can note minor differences in the maximum water uptake and hysteresis that can be attributed to experimental error and intrinsic differences between the small and larger batch of NPS.

### NPS Isotherms—Temperature Dependence

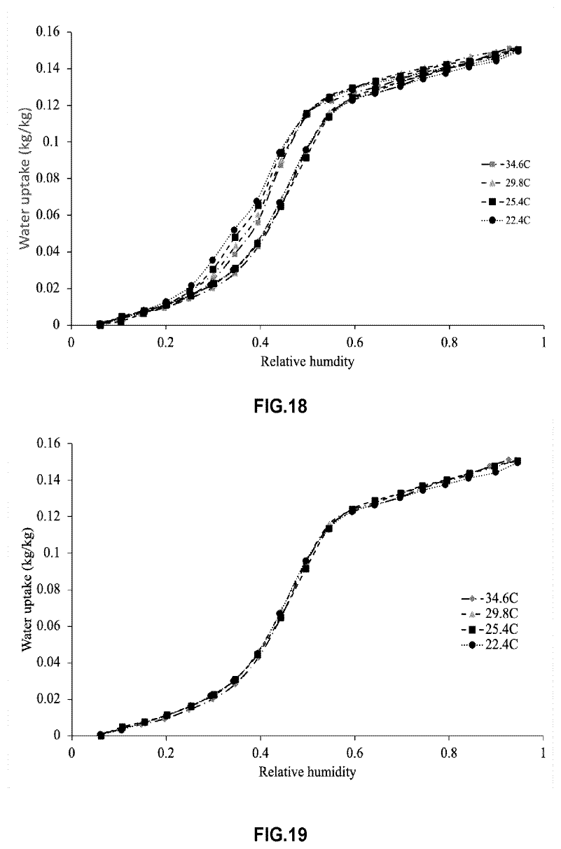

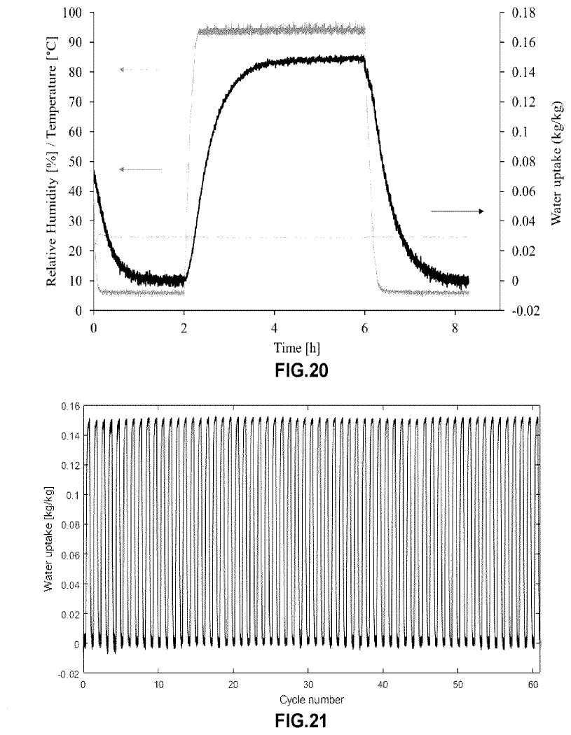

The influence of the atmospheric temperature on the adsorption and desorption behavior of the NPS has been assessed in the environmental chamber, by recording isotherms at three different temperatures (FIG. 18). While the adsorption part is highly similar in the range 22.4-34.6° C. (FIG. 19), the hysteresis between the adsorption and desorption is shrinking when the temperature is increased. It shows that the desorption is facilitated at relatively higher temperature, confirming the observation done in FIG. 12.

### NPS Cyclability

Cycles of adsorption and desorption are studied in the environmental chamber by varying the relative humidity from 5 to 95% at constant temperature. A typical cycle is presented on FIG. 20, while repetitions of these cycles are shown on FIG. 21. It confirms that the NPS performance remain constant over cycles. The kinetics of adsorption have been fitted with a simple exponential function under the form:

F(t)=F₀ (1−e^{-kt}) (Equation 15)

Values for F₀ and k were found at 0.146 kg/kg and 1.95 h⁻¹ and remained constant over the different cycles.

### Diffusion Models

### Intra-Particle Diffusion

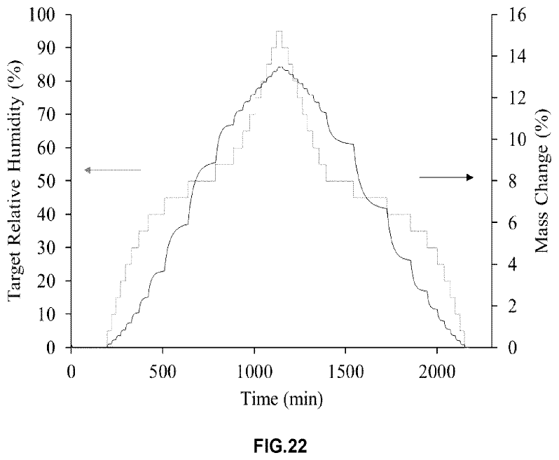

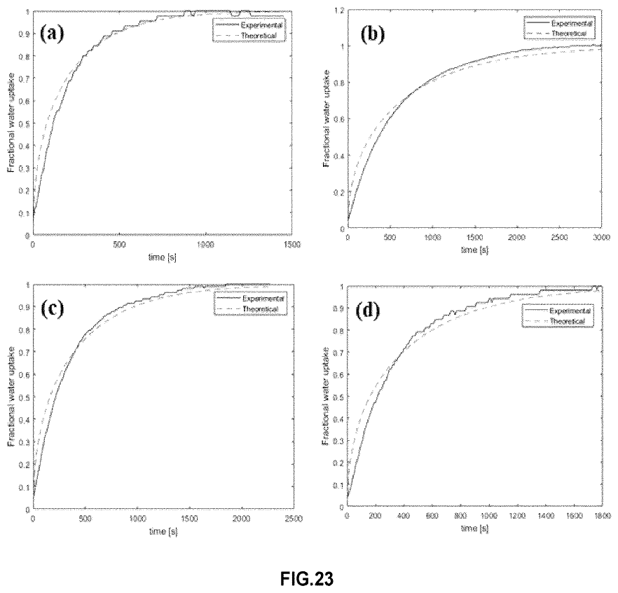

The solution to Fick's law of diffusion (Equation 4) is used to determine the coefficient of intra-particle diffusion. This diffusion coefficient is dependent on temperature and relative humidity. Thus, it is possible to estimate an average value for a certain range of experimental conditions. As seen on FIG. 22, kinetics data are available from DVS at each step from 5 to 95% RH, based on measurement from small batch of NPS whose spherical particle have a radius of 1.9 μm. The Equation 4 is fitted for each adsorption step, with several examples shown on FIG. 23. The summary of the diffusion coefficients over the entire range of relative humidity is provided in Table 7. It can be deduced that the average diffusion coefficient at 30° C. and from 5 to 95% RH is equal to 7.3±4.3·10−16 m²/s.

TABLE 7
Summary of the diffusion coefficient based on the DVS data.

| RH | | | | | | | | | | | | | | | | | | |
|---|---|---|---|---|---|---|---|---|---|---|---|---|---|---|---|---|---|---|
| (%) | 5 | 10 | 15 | 20 | 25 | 30 | 35 | 40 | 45 | 50 | 55 | 60 | 65 | 70 | 75 | 80 | 85 | 90 |
| D_{μ} | 13 | 16 | 12 | 10 | 8 | 6 | 4 | 2.3 | 1.3 | 1.2 | 2.1 | 4.5 | 6.5 | 8.5 | 8.5 | 9 | 9.5 | 9.3 |
| (×10⁻¹⁶) | | | | | | | | | | | | | | | | | | |
| [m²/s] | | | | | | | | | | | | | | | | | | |

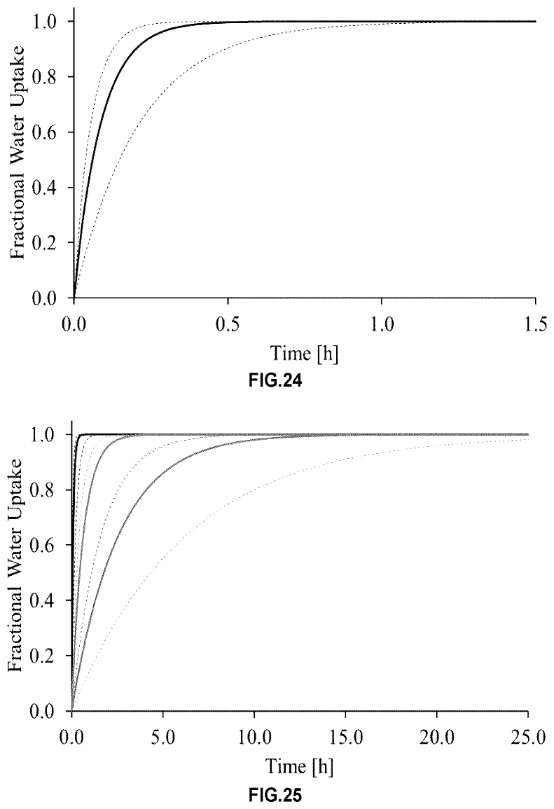

Based on the average diffusion coefficient previously obtained, it is possible to predict the overall kinetics of adsorption to pass from a specific RH value to another. The linear driving force model is employed for NPS at 30° C. for an adsorption step from 5 to 95%. The resulting kinetics are shown on FIG. 24, taking into account the uncertainty range. It can be seen that it takes up to an hour to fully adsorb water in a single particle having a radius of 1.9 μm.

Assuming the diffusion coefficient would remain identical for any particle size, the effect of the particle radius on the adsorption kinetics was investigated, shown on FIG. 25. While it took up to 1 h to fully adsorb water for a single NPS particle having a radius of 1.9 μm, this time increased to 8 h and 25 h for particle radiuses of 5 and 10 μm.

While smaller particle radius is more favorable for intra-particle diffusion, it is important to recall that smaller particles have a more limited inter-particle diffusion since the resistance to flow increases. As such, an optimal point must be found in the particle radius to take into account of both the intra- and inter-particle diffusion, based on the mass and energy transport model discussed in the following section.

### Mass and Energy Transport

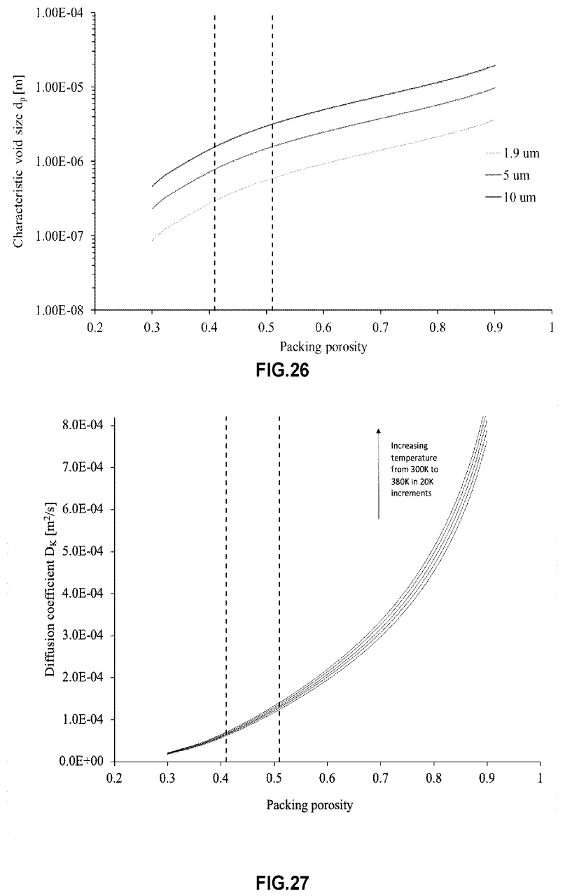

Before resolving the equation of mass and energy transport in an adsorption layer, several parameters have to be determined following the equations described in the methodology section. The packing porosity of the NPS adsorbent layer is determined by measurement of the apparent and powder densities and is equal to 0.46±0.05. The characteristic void size is calculated based on several particle radiuses, identical to those considered in the intra-particle diffusion (1.9, 5 and 10 μm) and is shown on FIG. 26. The Knudsen coefficient is calculated for a specific particle size and different temperatures, on FIG. 27. For a particle radius of 1.9 μm, at a temperature of 300 K and a packing porosity of 0.46, the Knudsen coefficient is equal to 8.67·10−5 m²/s, resulting in an inter-particle diffusion coefficient of 6.64·10−6 m²/s.

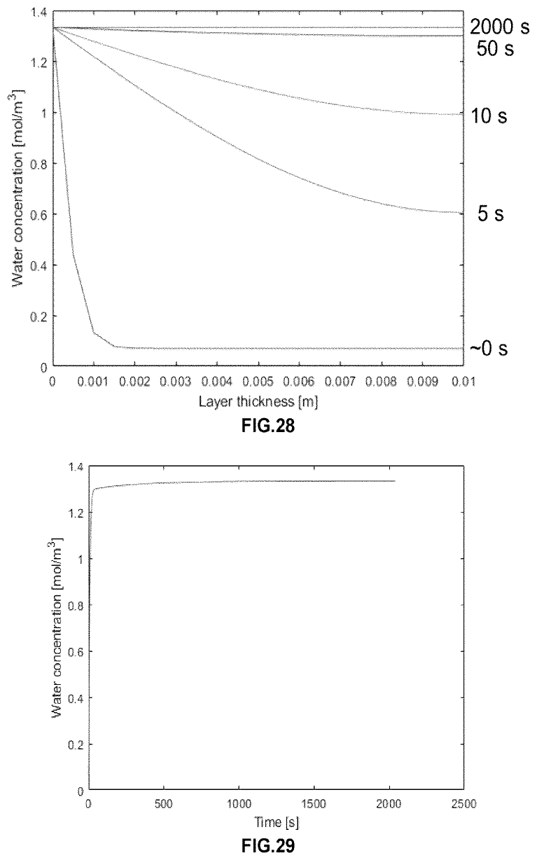

The mass and energy transport equations are solved for a 1 cm thick NPS layer. The water concentration profiles are shown on FIG. 28. It is important to mention that the water concentration corresponds to the concentration in the air, meaning that when the concentration reaches equilibrium at the maximum value, there is no more diffusion nor adsorption occurring, happening around 2000 s, from the graph.

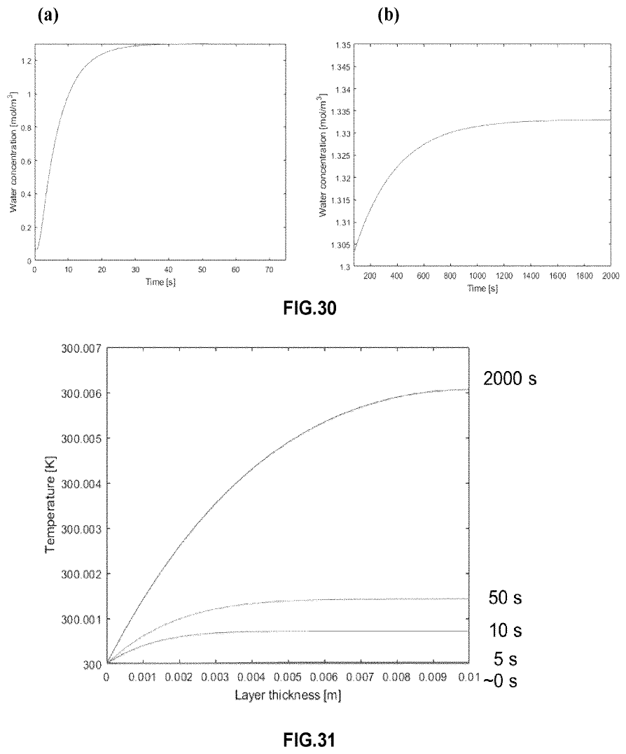

In order to extract kinetics data, a position at the extremity of the layer (L=0.01 m) is arbitrarily chosen and the water concentration is plotted in function of time, as shown on FIG. 29. The water concentration is increasing quickly in the first seconds before increasing slowly and reaching the maximum value. This difference in the water concentration increase is due to the intra- and inter-particle diffusion phenomena which have different time scales. To better visualize the contribution from the two effects, FIG. 30 shows zoomed-in sections of the two regions. The region in the first seconds is dominated by inter-particle diffusion, where the water molecules quickly diffuse between the particles. After that, the slowest phenomenon corresponds to the intra-particle diffusion where the water molecules need to diffuse in the 1.5 nm pores of the NPS. Finally, when the NPS particle have adsorbed their maximum water uptake, the water concentration is equilibrated, at approximately 2000 s.

In the specific case of spherical particles having a radius of 1.9 μm, it can be concluded that the main phenomenon driving the kinetics is the intra-particle diffusion. Additional calculations need to be done to study these kinetics when the particle radius is reduced.

The temperature profiles in the adsorbent layer are depicted on FIG. 31. It can be seen that the temperature barely increases in the layer due to the adsorption. The heat generated by the water adsorption occurs over a relatively long time (2000 s), meaning the heating power is very low at a specific time. On top of that, carbon powder has a thermal conductivity allowing to dissipate the heat before it accumulates in the NPS material. The measured value for thermal conductivity was 0.1 W/m·K. Having a material with a temperature barely increasing during the adsorption is important for the material performance. LaPatin et al. mentioned that porous adsorbents, and more specifically MOFs have low thermal conductivity that can be compared to insulating materials [41]. As a result, heat can be trapped in the adsorbent particles, reducing the amount of water that can be adsorbed and obtaining overall poor performance. To overcome this issue with MOFs, thermal binders can be added, such as metallic foam or carbon particles [41].

### Conclusion

In conclusion, further characterization and understanding of the NPS material in the water adsorption application were obtained. Through experimental and theoretical work, it has become possible to draw several conclusions and confirmations from preliminary results:

Validation of the scalability of the synthesis protocol: The water uptake of 0.15 kg/kg in the NPS material is maintained from 100 mg to 30 g samples. The main difference lies in the morphology of the particles, where they are spherical for the small batch with diameters below 4 μm while particles with diameters of tens of pm are observed for larger batches. This difference can be compensated through fine crushing of the largest particles.

Validation of the cyclability of the NPS: The water uptake and kinetics of adsorption are maintained over 10 adsorption/desorption cycles.

Mechanism of the NPS adsorption: Literature is providing the mechanism steps of the adsorption of water on carbon-based material, through the Do & Do model. Recording adsorption isotherms and application of the theoretical model led to the identification of the primary adsorption sites, the hydroxyl groups.

Kinetics of the water adsorption in the NPS: Through mass and energy transport equations in a packed adsorbent layer, it is possible to simulate the required time to reach equilibrium for a given adsorbent configuration. For NPS particle radius of 1.9 μm in an adsorbent layer of 1 cm, it takes approximately 2000 s to reach equilibrium.

These conclusions confirm the applicability of the nanoporous sponges of the present application in industrial applications. As such, the scalability may be extended to even larger batches of NPS samples, in order to build a prototype of water capture device. Additional cycles, up to 100, may be recorded to further confirm the cyclability. The NPS are mostly composed of carbon sp², and are, by nature, a very stable material over the time. In order to increase the maximum water uptake of the NPS, initial composition and functionalization of the synthesized material may be studied, with the objective to increase hydroxyl group concentration on the surface of the NPS. Several methods are considered, such as modifying the nature of the initial precursors, or addition of hydroxyl groups through heat treatments with water or peroxide precursors or eventually by acid or plasma treatment. A secondary objective to study the composition and functionalization of the NPS is to reduce the mass loss occurring during synthesis to lower the production cost of the material. Experimental work showed potential temperature dependant property in the water adsorption. This phenomenon needs to be studied. Thermodynamic properties of the NPS may also be further investigated. The mass and energy transport model may be continued to better define the kinetics of the water adsorption in the NPS. The objective is to determine the optimal particle size in a packed layer that maximize both inter-particle diffusion and water adsorption to increase the number of adsorption/desorption cycles per day. The diffusion model may be confronted to a forced flow model, where the water vapor is pushed through a layer or a column of adsorbent. All of this information may provide some design tools to adapt the NPS technology as an industrial scale.

### Example 3—Sorbents Materials Analysis

The thermodynamic properties are assessed for five samples. They consist of nanoporous sponges (NPS), oxidized nanoporous sponges (O-NPS), silica gel and two metal-organic frameworks (MOFs): MOF-801-P and Cr-MIL-101. NPS and O-NPS were obtained were obtained as described above.

Silica gel (type A, Dry-Packs( ) was purchased from Amazon. Finer powders of silica gel were obtained by grinding of the gel beads for 20 s in a Simplicite automatic grinder. Cr-MIL-101 and MOF-801-P were respectively chromium- and zirconium-based MOFs that were already described in literature [48-51]; both were purchased from Nanoshel-UK LTD. A simplification of the surface chemistry of the different sorbents studied is shown below in Scheme 1.

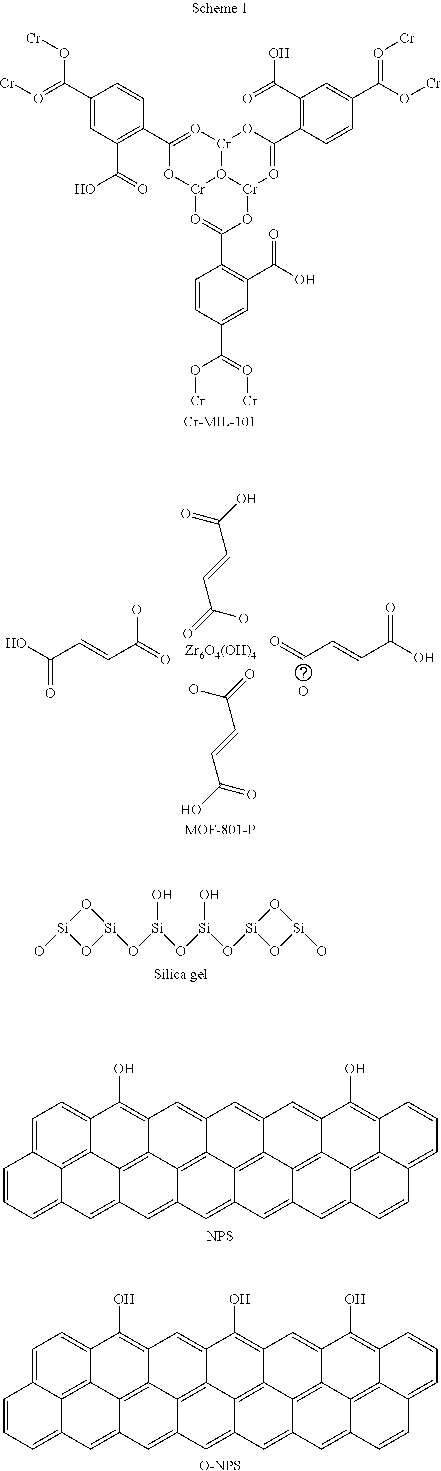

### Environmental Chamber

Water adsorption isotherms were measured for each sorbent, at three temperatures: 25, 30 and 35° C. The measurement of these isotherms was performed in a custom-made and fully automated environmental chamber employing a gravimetric method. In this method, the weight of the sample is continuously measured while the relative humidity varies and the temperature remains constant. A 3-5 g sample of sorbent was dispersed on a thin layer in a 71 cm² glass dish suspended under an AB204-S analytical balance from Mettler Toledo.

Relative humidity (RH) was controlled by a humidifier and a solenoid valve connected to a dry air inlet. Temperature was controlled with a heater for the duration of the experiment. Also, a fan kept the conditions homogeneous in the entire volume of the environmental chamber. The humidifier, solenoid valve, heater and fan were controlled by an ArduinoTM via a Python interface. Prior to isotherm measurement, the samples were left to dry in the environmental chamber for several hours until mass equilibration was reached. The adsorption isotherm protocol involved increasing the RH in 5 % steps from 5 to 95 % RH, and each step was maintained (1-4 h) until the sorbent mass could equilibrate.

### Thermodynamic Equations

Water adsorption isotherms were fitted applying the Stineman's algorithm [52] using the KaleidaGraph 4.5 (Synergy) software package. This fitting allowed extrapolating 100 data points based on the experimental isotherms.

Gibbs molar free energy was estimated using Equation 16:

ΔG =RTln(a_{w}) (Equation 16)

where T [K] is the absolute temperature, R [J/mol·K] is the universal gas constant and a_{w}(=RH/100) [−] is the water activity.

To calculate the differential enthalpy or isosteric heat, the methodology reported by Flores-Andrade et al. was applied [53]. First, Othmer's equation (Equation 17) was used to determine the changes in differential enthalpy at the water—solid interface at different stages of adsorption [54]:

$$ln ( {P}_{v} ) = {( \frac{{H}_{v} ( T )}{{H}_{v}^{0} ( T )} )}_{M} ln {P}_{v}^{0} + {C}_{1} \qquad ( Equation 17 )$$

Where M [g H₂O/100 g dry sorbent] is the air moisture, Hᵥ(T) [J/mol] is the isosteric heat for water sorption, Hᵥ⁰(T) [J/mol] is the heat of condensation for pure water and C₁ is a constant of adsorption, Pᵥ[Pa] is the partial vapor pressure of water in the system and Pᵥ[Pa] is the standard state vapor pressure. By plotting In(Pᵥ) vs. In(Pᵥ⁰), a straight line can be obtained if the ratio Hᵥ(T)I Hᵥ⁰(T) is constant for the studied range of temperature. The differential adsorption molar enthalpy ΔH_{diff}[J/mol] or net isosteric heat of adsorption was then computed with Equation 18:

$${( Δ {H}_{djff} )}_{T} = {( \frac{{H}_{v} ( T )}{{H}_{v}^{0} ( T )} - 1 )}_{M} {H}_{v}^{0} ( T ) \qquad ( Equation 18 )$$

The differential enthalpy values previously calculated were used to calculate the change in the molar differential entropy ΔS_{diff}[J/mol], following the methodology reported by Flores-Andrade et al. [53] using Equation (19):

$${( Δ {S}_{diff} )}_{T} = - \frac{{( Δ {H}_{diff} )}_{T}}{T} - R ln {a}_{w} \qquad ( Equation 19 )$$

The molar integral enthalpy (ΔHᵢₙₜ)_{T}[J/mol] was calculated by maintaining diffusion pressure (ϕ) constant, as reported by Flores-Andrade et al. [53] using Equation 20. The diffusion pressure is the available work to adsorb humidity. Rowley and Innes defined it as the total reversible work involved in the formation of an interface between the condensed water and the gas [55].

$${( Δ {H}_{int} )}_{T} = {( \frac{{H}_{v , int} ( T )}{{H}_{v}^{0} ( T )} - 1 )}_{ϕ} {H}_{v}^{0} ( T ) \qquad ( Equation 20 )$$

where Hᵢₙₜ(T) [J/mol] is the integral molar heat of water adsorbed in the material, Hᵥ⁰(T) [J/mol] is the heat of condensation for pure water and can by determined with the Wexler equation (Equation 21), valid between 0 and 100° C. [56]:

Hᵥ⁰(T)=6.15×10⁴−94.14T+17.74×10⁻²T²−2.03×10⁻⁴T³ (Equation 21)

The diffusion pressure ϕ can be found via Equations 22 and 23:

$$ϕ = {μ}_{ap} - {μ}_{a} = RT \frac{{W}_{ap}}{{W}_{v}} {\int }_{0}^{{a}_{w}} Md ln ( {a}_{w} ) \qquad ( Equation 22 )$$

$$ϕ = {α}_{1} T \text{?} Md ln ( {a}_{w} ) \qquad ( Equation 23 )$$

$$\text{?} \text{indicates text missing or illegible when filed}$$

where μₐₚ [J/mol] is the chemical potential of the pure adsorbent, μₐ [J/mol] is the chemical potential of the adsorbent in the condensed phase, Wₐₚ [kg/mol] is the molecular weight of the adsorbent, and Wᵥ[kg/mol] is the molecular weight of water.

The changes in the molar integral entropy (ΔSᵢₙₜ)T [J/mol] were calculated as reported by Pascual-Pineda et al. and Acosta-Dominguez et al. in Equation 24 [57,58]:

$${( Δ {S}_{int} )}_{T} = {S}_{1} - {S}_{L} = - \frac{{( Δ {H}_{int} )}_{T}}{T} - R ln ( {a}_{w} ) \qquad ( Equation 24 )$$

where S₁=S/N₁[J/mol·K] is the integral entropy of the water adsorbed; S [J/ K] is the total entropy of water adsorbed in the adsorbent; N₁ [mol] is the moles of water adsorbed in the adsorbent, and S_{L} [J/mol·K] is the molar entropy of the pure liquid water in equilibrium with the vapor.

### Results

### Sorbent Surface Chemistry

The five studied sorbents presented various surface chemistry and physical properties and were thus expected to have different thermodynamic properties (Table 8). Simplified surface chemistry is illustrated in Scheme 1.

Silica gel can be considered as a polymeric form of silicic acid in an amorphous network of SiO₄ tetrahedra. The surface is terminated by either siloxane (—Si—O—Si—) or silanol groups (—Si—OH) and thus exhibits high oxygen concentration, rendering it hydrophilic [61]. On average, 3.1 —OH groups per nm² are present on the surface, with irregular distribution [62]. For the rest of the sorbents, the hydroxyl surface concentration was estimated based on available atomic O concentration from XPS, and surface area measurement from BET. NPS and O-NPS were derived from the pyrolysis of resorcinol-formaldehyde resin pyrolysis (with an oxidation step added for O-NPS) and are thus mostly composed of carbon sp², with slightly more oxygen for O-NPS compared to NPS. Among the oxygen moieties contained on the carbon-based sorbents, —OH groups were identified as primary adsorption sites using the Do & Do model [23]. NPS and O-NPS contained respectively 0.5 and 0.8 —OH groups per nm². Cr-MIL-101 was synthesized from Cr(NO₃)₃·9H₂O salt and trimesic acid. The resulting sorbent material contained a high oxygen concentration on its surface. However, most of these oxygen atoms were involved in the MOF structure where they were linked to Cr atoms, and thus only a few oxygen atoms from carboxylic moieties would be able to participate in the water adsorption process.

From surface analysis data in [49,60], it was estimated there were 1.5 —OH groups per nm². Many derivatives of Cr-MIL-101 could be found in the literature by functionalizing the organic linkers with various groups such as —NH₂, —NO₂ or SO₃H [49]. MOF-801-P was synthesized from ZrOCl₂·8H₂O salt and fumaric acid. Similar to Cr-MIL-101, most oxygen atoms participated in the MOF structure, and it was estimated that only 1.8 —OH groups per nm² were available for water adsorption.

TABLE 8
Physical properties and surface chemistry of the sorbents

| | Silica gel | NPS | O—NPS | Cr-MIL-101 | MOF-801-P |
|---|---|---|---|---|---|
| Sorbent | [symbol] | [symbol] | [symbol] | [symbol] | [symbol] |
| Surface area (m²/g) | 650 | 487 | 484 | 990 | 1300 |
| Pore size (nm) | 2.2 | 1.5 | 1.7 | 2.0 | 0.5 |
| XPS composition | Si: 33.3O: | C: 93.8O: | C: 93.0O: | C: 48.9O: | C: 20.3O: |
| (at %) | 66.7 | 6.2 | 7.0 | 33.1 Cr: | 45.1 Zr: |
| | | | | 18.0 | 34.6 |
| Estimated —OH | 3.1 | 0.5 | 0.8 | 1.5 | 1.8 |
| concentration | | | | | |
| (—OH/nm²) | | | | | |

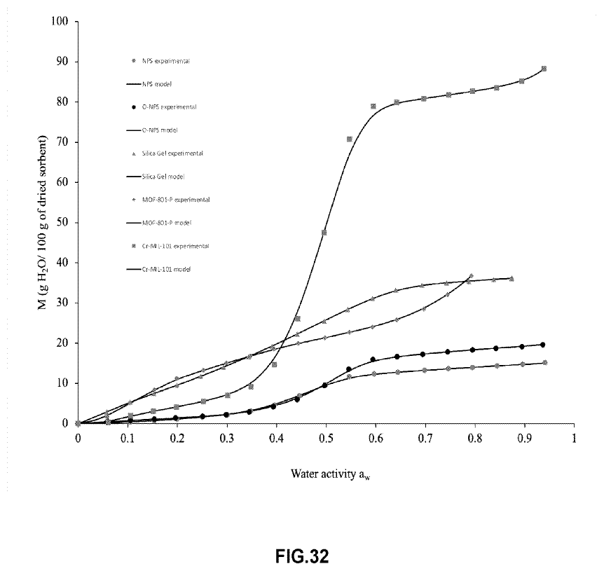

Adsorption isotherms at 30° C. for the five studied sorbents are presented in FIG. 32. NPS and silica gel exhibited decreasing equilibrium moisture content when increasing temperature at constant water activity due to the exothermic nature of the adsorption process [56]. O-NPS, MOF-801-P and Cr-MIL-101 had several regions of the isotherms where the opposite phenomenon was observed, and the equilibrium water constant increased with increasing temperature.

NPS, O-NPS and Cr-MIL-101 isotherms presented a type V shape, according to the classification proposed by the International Union of Pure and Applied Chemistry (IUPAC); this is an S-shaped isotherm commonly found on various charcoals, carbon black and more generally hydrophobic materials [63]. Non-porous carbons with a void or small presence of Oxygen Functional Groups (OFGs) such as graphite or Graphitized Carbon Black (GCB) would present a Type III isotherm instead [64]. Silica gel was in good agreement with the experimental isotherms from literature [59]. However, it was observed that the isotherm from the commercial MOF-801-P deviated from literature reports, especially at low water activity, where the isotherms from literature exhibit a sharp increase [31]. Due to the constituency and adequacy of the other isotherms, it was concluded that this behavior came from the sample itself, and that scale-up of the MOF-801-P sorbent synthesis might have altered its adsorption properties.

### Gibbs Free Energy

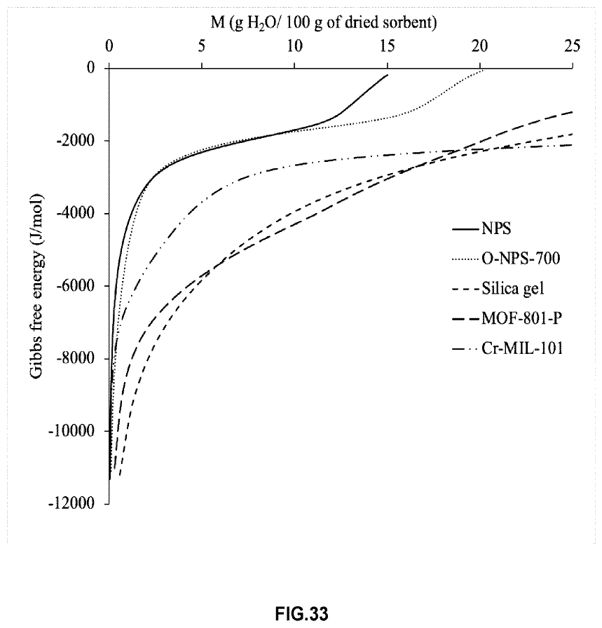

Gibbs free molar energy of the different sorbents are shown in FIG. 33 as a function of moisture (M, g_{H2O}/100 g of dried sorbent). Free energy increased with increasing water activity; thus, the process was less spontaneous as the sorbent moisture increased. It was also observed that at low moisture content and with increasing temperature, adsorption was less spontaneous since more energy was required for adsorption to occur [71]. At higher moisture, the reverse phenomenon happened for sorbents that had higher water uptakes at higher temperatures.

Gibbs free energy was also used to compare the hygroscopicity of the sorbents, i.e. the facility for a sorbent to adsorb water vapor from its surrounding environment. The lowest energy values were correlated to the most hygroscopic materials. Silica gel appeared to be the most hygroscopic material, followed by the two MOFs, Cr-MIL-101 and MOF-801-P, and then the carbon-based samples, NPS and O-NPS. This behavior aligns with the —OH concentration on the sorbents' active surface area, and more generally with the surface chemistry. Both NPS and O-NPS samples reached a “plateau” rapidly at around -2000 J/mol during the adsorption process, which suggested that water was adsorbed with homogenous spontaneity over a considerable range of RH.

### Enthalpy of Adsorption

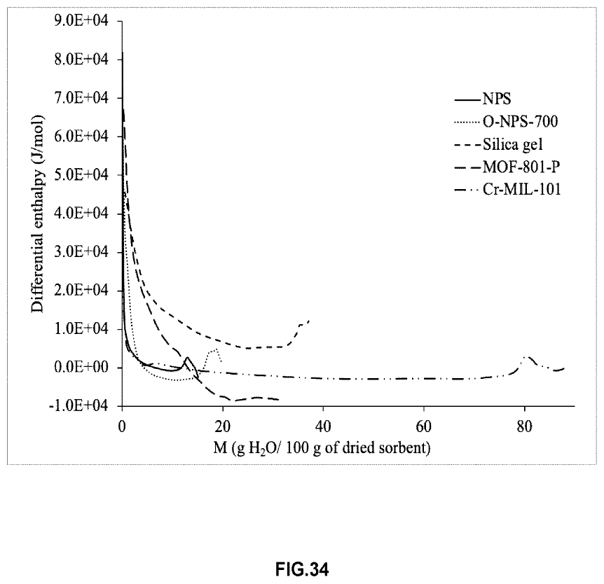

The net isosteric heat of adsorption or differential enthalpy at 30° C. are presented in FIG. 34. At low water activities, the differential enthalpy was higher than the enthalpy of vaporization of pure water for all the samples, indicating that the interactions between the water molecules and the surface of the sorbent material were higher than the intermolecular forces of water molecules in the liquid state (bulk). The net isosteric heat of adsorption decreased exponentially when increasing the water activity, evidence that the highly active sites (—OH groups) were being occupied as the adsorption process evolves. After that, differential enthalpy slightly oscillated close to the reference (pure water), meaning that the enthalpy of adsorption was practically the same as the heat of vaporization of water at each specific temperature (˜44 kJ/mol). Liu et al. (2017) concluded that during the main pore filling in porous carbons, the isosteric heat was close to the heat of condensation because the water adsorption was governed by water-water interactions [62]. One should note that the NPS sample presented an equivalent behavior to the commercial Cr-MIL-101 adsorbent, i.e., relatively low water-absorbent interactions when compared to silica gel and MOF-801-P. The weak interactions on the NPS and O-NPS became advantageous for water harvesting applications since less energy would be required to dry the sorbent before using it again in a cyclical adsorption-desorption process.

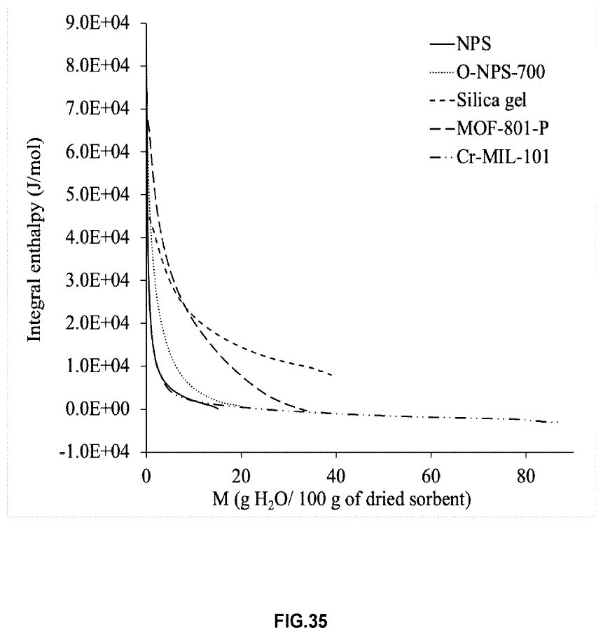

The integral enthalpy of the different sorbents at 30° C. are shown in FIG. 35. This property represents the average energetic state of the adsorbed water on the surface of the material. That is, the average interactions between water molecules and adsorbent at a specific moisture content [52]. Integral enthalpy was directly correlated to the amount of energy released during water adsorption. The highest amount of energy was released for the first water molecules being adsorbed, which had the highest water-sorbent interaction. This behavior could be employed to better understand energy release during the adsorption step and optimize the energy management in a water capture set-up, where heat was demonstrated to be a limiting step in certain cases [41,72].

The moisture content was defined as a percentage of the maximum water uptake % Mₘₐₓ. For example, 30% Mₘₐₓ of silica gel would correspond to 11.5 g_{H2O}/100 g_{sorbent}. Taking into account the heat of vaporization for pure water at 30° C., adsorbing water from 0 % Mₘₐₓ to 30% Mₘₐₓ for silica gel would release an average energy of 63.5 kJ/mol, compared to 51.5 kJ/mol to adsorb water from 0% Mₘₐₓ (dry sorbent) to 100% Mₘₐₓ, due to high water-adsorbent interaction at low moisture content. The summary of the released heat of adsorption for different cases applied on all sorbents iss shown in Table 9. These simple cases show that the samples with the lowest water-sorbent interactions at higher water activity, i.e. NPS and Cr-MIL-101, released lower amounts of energy than silica gel and MOF-801-P, which have higher water-sorbent interactions. In other words, the amount of energy released during the adsorption, and by analogy the required energy for desorption, could be controlled in an actual water capture set-up by setting the moisture content levels during cycles of adsorption-desorption. O-NPS was considered as an intermediate in terms of water-sorbent interactions between NPS and Cr-MIL-101 on one side and silica gel and MOF-801-P on the other side.

TABLE 9
Heat of adsorption released during three
adsorption cases for the sorbents

| | Heat of | Heat of | Heat of |
|---|---|---|---|
| | adsorption | adsorption | adsorption |
| | for 0% Mₘₐₓ → | for 0% Mₘₐₓ → | for 0% Mₘₐₓ → |
| | 10% Mₘₐₓ | 30% Mₘₐₓ | 100% Mₘₐₓ |
| Sorbent | (kJ/mol) | (kJ/mol) | (kJ/mol) |
| NPS | 57.5 | 49.3 | 43.8 |
| O—NPS | 71.5 | 54.0 | 44.3 |
| Silica gel | 75.9 | 63.5 | 51.5 |
| MOF-801-P | 81.1 | 63.7 | 43.2 |
| Cr-MIL-101 | 45.8 | 43.4 | 40.6 |

The enthalpy of adsorption for silica gel has already been characterized in the literature. Chakraborty et al. determined that silica gel type RD had an enthalpy of adsorption at 30° C. of 2,550 kJ/kg, i.e. 46.0 kJ/mol [65]. Ng et al. reported a value of 2,380 kJ/kg, i.e. 42.8 kJ/mol for silica gel type 3A and 45.2 kJ/mol for silica gel type RD. Chua et al. reported values of 48.8 and 48.5 kJ/mol for silica gel of respectively type A and type RD [67]. The enthalpy of adsorption varied from a silica gel type to another, but variations were also observed for the same type of silica gel, depending on the studies. It appears that the present study slightly overestimated the enthalpy of adsorption compared to available literature data. Explanations for this could include the material itself, purchased from a large-scale commercial supplier, and experimental errors that make difficult the precise determination of moisture content at low water activity and potentially causing variations in the thermodynamic properties. Enthalpy of adsorption was also studied in literature for MOF-801-P. Kim et al. determined values of 55 kJ/mol for this sorbent at 30° C. while Furukawa et al. reported enthalpy of adsorption of 60 kJ/mol at similar temperature [32].

### Entropy

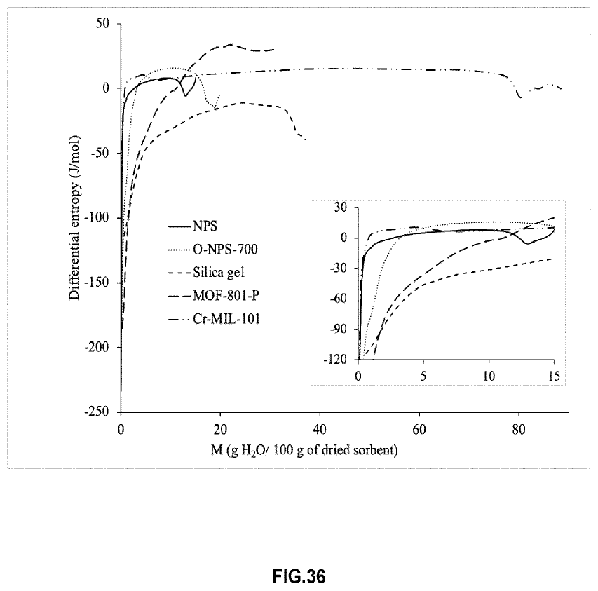

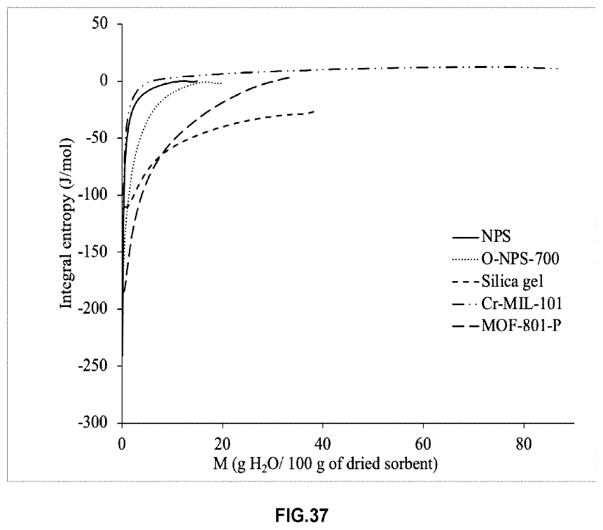

Differential and integral entropy are respectively presented in FIG. 36 and FIG. 37. Statistical thermodynamics describes entropy as the distribution of the system energy in a number of possible microscopic states at thermodynamic equilibrium [69]. Applied to water adsorption, entropy corresponds to the energy spreading or dispersing by adsorbed water molecules, and the impact of intermolecular interaction between the water molecules and the sorbent surface on the energy dispersal within the system. It is important to point out that the differential adsorption molar entropy does not represent the energy spreading of the entire system, instead it shows the contribution to the energy spreading when the last molecules of water are adsorbed at a specific water level [52]. As such, this property allows the determination of the water content for which new arriving molecules do not affect the energy spreading of the system for each sample. This is valuable information for the design and scale-up of sorbent technologies for water recovery, since it allows to predict the minimal drying conditions for the sorbent before it is used again to adsorb water in a cyclical system. Indeed, new arriving water molecules that do not contribute to the energy spreading would practically arrange in an equivalent way as they would do in pure water. This implies that extraction conditions will then be equivalent as in pure water. An equivalent shape or behavior of the differential entropy has been observed in a MOF [70]. It can be observed that, for the NPS and the Cr-MIL-101 samples, differential entropy rapidly reaches a value of 0, indicating that additional molecules of water being adsorbed become equal to the molar entropy of liquid water in equilibrium with gaseous water. Even though the energy dispersal for the MOF-801-P sample is affected at low water contents, it also becomes stable close to 0 at around 13 g H₂O/100 g of MOF-801-P. Silica gel was the sample where the energy dispersal is least affected by the new arriving molecules due to the higher energy sites and higher water-sorbent interactions.

Integral entropy represents the average entropy of the entire system and is shown in FIG. 37. This property is defined as the integral entropy of the water in the adsorbed state minus the molar entropy of the pure liquid water in equilibrium with the vapor (S₁-S_{L}). It then allowed the observation that, for most of the sorbent the adsorption process, the energy of the water molecules spreads in an equivalent way as it would in pure liquid water. Overall, NPS and Cr-MIL-101 saw their integral entropy rapidly converge to 0, showing the energy of the adsorbed water rapidly reached the same distribution of microscopic states than pure water. The integral entropy of MOF-801-P also converged towards 0, but the water molecules remained in a lower energy dispersal before fully filling the sorbent. Water molecules in silica gel did not reach the entropy of pure water and the strong interactions with sorbent surface maintained a lower energy dispersal. This also shows that it is entropically advantageous to adsorb water up to the maximum uptake, especially for NPS and Cr-MIL-101. It is not necessary to completely dry the samples before using them again in a cyclical process since a more negative entropy is correlated with higher difficulty to remove them from the sorbent. From a practical point of view, this implies that NPS and Cr-MIL-101 should maintain a moisture content of 3-5 g_{H2O}/100 g of dried sorbent between cycles to ensure that the system keeps an entropy close to that of pure water. This condition could be achieved by performing adsorption—desorption steps with a lower limit at 20-35% RH.

The five studied sorbents exhibited various levels of —OH concentration on their active surface area, as shown in Table 8 [23]. The different thermodynamic properties were correlated with these surface chemistries. Gibbs free energy confirmed the hygroscopicity of the sorbents. At low RH, the carbon-based sorbents, NPS and O-NPS, were the least hygroscopic samples while silica gel had the highest hygroscopicity. In terms of integral enthalpy, the sorbents with the lowest —OH surface concentration had the highest enthalpy adsorption at low moisture content, due to a higher water-sorbent interaction. However, the adsorption enthalpy for these samples converged more rapidly towards the heat of vaporization of pure water than for the samples with higher water-sorbent interactions. Similar trends were observed with the integral entropy, where NPS, O-NPS and Cr-MIL-101 had lower values of entropy at low moisture content, indicating a higher number of possible microscopic states of the first adsorbed molecules. The integral entropy of these samples was converged rapidly towards 0, equivalent of the entropy of pure water. In contrary, silica gel and MOF-801-P kept lower integral entropies for higher moisture content, due a higher water- sorbent interaction and preventing the dominance of water-water interactions.

Despite a general good agreement between the —OH concentration and thermodynamic behaviors, some discrepancies were still observed for enthalpy and entropy. This illustrates that water adsorption is a more complex phenomenon, and several additional parameters should be considered. For example, even if —OH groups were identified as primary adsorption sites for NPS and O-NPS, surface chemistry could be more complex with other moieties having various repulsive or attractive behavior towards water. On top of the surface chemistry, water adsorption also depends on the pore size and geometry. For example, sudden variations in the pore diameter could locally lead to pore blocking, one of the potential causes for hysteresis between adsorption and desorption [9]. The present example focused mainly on the thermodynamic properties of the sorbent during the adsorption step. While hysteresis during desorption is likely to affect the thermodynamic behavior of the sorbent, one should expect only minor differences between adsorption and desorption integral properties. This is because the thermodynamic properties of interest are mainly extracted in the low humidity region (water activity=0-0.2) where the sorbent surface-water molecules interactions are the strongest and the hysteresis is minimal.

### Conclusion

The thermodynamic properties of five sorbents (Cr-MIL-101, MOF-101, silica gel, NPS and O-NPS) have been assessed based on their adsorption isotherms at three temperatures. The thermodynamic properties of silica gel were in good agreement with those found in literature. Gibbs free energy gave insight on the spontaneity of the adsorption process and on the hygroscopicity of the sorbent's surface, which was correlated with the surface chemistry and more specifically the —OH surface concentration. Enthalpy of adsorption demonstrated that the highest amount of released energy occurred for the first adsorbed water molecules that had the highest water-sorbent interaction. The changes in adsorption enthalpy between the analyzed sorbents could be mostly correlated with the surface chemistry; other parameters could potentially affect the thermodynamic properties, such as pore size distribution and surface heterogeneity. Based on the enthalpy of adsorption, it could be possible to optimize the amount of released energy by performing incomplete desorption between adsorption steps, particularly for the most hydrophobic sorbents, namely NPS and Cr-MIL-101. Entropy provided information on the distribution of microscopic states in adsorbed water molecules, which is related to the energy spreading or dispersing within the system. While the most hydrophobic sorbents rapidly reached a similar entropy to that of pure liquid water, silica gel maintained a lower entropy due to higher water-sorbent interactions. It showed that it was entropically advantageous to entirely use the materials to adsorb water and set conditions to avoid complete desorption.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

### REFERENCES

[1] Pajares, P. et al., Highlands and dryland mountains, a source of resilience in arid regions. 2011;
[2] Zotalis, K et al., Desalination Technologies.Hellenic Experience Water, 2014. p. 1134-1150.
[3] Thiel G. P., Salty Solutions. Physics Today 2015: p. 66-67.
[4] R. V. Wahlgren, Atmospheric water vapour processor designs for potable water production: a review, Water Research, 35, 1(2001) p. 1-22.
[5] F Fathieh et al Practical water production from desert air, Science Advances, Vol.4, no. 6, (2018)
[6] Park, K.-C et al., (2013). Optimal Design of Permeable Fiber Network Structures for Fog Harvesting. Langmuir, 13269-13277.
[7] T. Horikawa et al., Capillary condensation of adsorbates in porous materials, Advances in Colloid and Interface Science 169 (2011) 40-58.
[8] R. Szoszkiewicz et al., Nucleaton Time of Nanoscale Water Bridges. PRL 95, 135502 (2005).
[9] A. Grosman et al., Capillary Condensation in Porous Materials. Hysteresis and Interaction without Pore Blocking/Percolation Process, Langmuir.. American Chemical Society (2008) 24 (8) pp.3977.
[10] R. Babu et at Rapid, Microwave-Assisted Synthesis of Cubic, Three-Dimensional, Highly Porous MOF-205 for Room Temperature CO2 Fixation via Cyclic Carbonate Synthesis ACS Appl. Mater. Interfaces, 8, 49 (2016) p 33723-33731.
[11] M. J. Kalmutzki et al., Metal-Organic Frameworks for Water Harvesting from Air, Adv. Mater. 30 (2018) 1704304.
[12] Z Chen, Reticular Access to Highly Porous acs-MOFs with Rigid Trigonal Prismatic Linkers for Water Sorption, J. Am. Chem Soc. (2019), 141, 7, 2900-2905
[13] G.-P Hao et al., Unusual Ultra-Hydrophilic, Porous Carbon Cuboids for Atmospheric Water Capture, Angew. Chem. Int. Ed. (2015) 54. 1941-1945.
[14] B. P Biswal et al, Pore surface engineering +n porous, chemically stable covalent organic frameworks for water adsorption, J. Mater. Chem A (2015) 3, 23664-23669.
[15] F. Zhao et al, Super Moisture-Absorbent Gels for All-Weather Atmospheric Water Harvesting, Advanced Materials (2019) 31, 10.
[16] H. Kim et al, Water harvesting from air with metal-organic frameworks powered by natural sunlight, Science 356 (2017) 403-434.
[17] J. L. Miller, Metal-organic framework extracts water from thin air, Physics Today (2017) 70, 6, 16.
[18] T. Horikawa, J. Hayashi, and K. Muroyama, “Controllability of pore characteristics of resorcinol-formaldehyde carbon aerogel,” Carbon N. Y., vol. 42, no. 8-9, pp. 1625-1633, 2004.
[19] P.-A. Pascone, J. de Campos, J.-L. Meunier, and D. Berk, “Iron Incorporation on Graphene Nanoflakes for the Synthesis of a Non-noble Metal Fuel Cell Catalyst,” Appl. Catal. B Environ., vol. 193, pp. 9-15, 2016.
[20] D. D. Do and H. D. Do, “A model for water adsorption in activated carbon,” Carbon N. Y., vol. 38, pp. 767-773, 2000.
[21] M. Neitsch, W. Heschel, and M. Suckow, “Water vapor adsorption by activated carbon: A modification to the isotherm model of Do and Do [6],” Carbon N. Y., vol. 39, no. 9, pp. 1437-1438, 2001.
[22] S. Furmaniak, P. A. Gauden, A. P. Terzyk, and G. Rychlicki, “Water adsorption on carbons-Critical review of the most popular analytical approaches,” Adv. Colloid Interface Sci., vol. 137, no. 2, pp. 82-143, 2008.
[23] D. D. Do, S. Junpirom, and H. D. Do, “A new adsorption-desorption model for water adsorption in activated carbon,” Carbon N. Y., vol. 47, no. 6, pp. 1466-1473, 2009.
[24] A. J. Rieth, S. Yang, E. N. Wang, and M. Dinc\check{a}, “Record Atmospheric Fresh Water Capture and Heat Transfer with a Material Operating at the Water Uptake Reversibility Limit,” ACS Cent. Sci., vol. 3, no. 6, pp. 668-672, 2017.
[25] Y. Shiraishi et al., “Resorcinol-formaldehyde resins as metal-free semiconductor photocatalysts for solar-to-hydrogen peroxide energy conversion,” Nat. Mater., vol. 18, no. 9, pp. 985-993, 2019.
[26] T. Onodera, T. Mizukami, S. Suzuki, J. Kawaji, K. Yamaga, and T. Yamamoto, “Analysis of forming process of nitrogen-doped carbon catalyst derived from Fe 1,10-phenanthroline compound and its oxygen reduction reaction activity,” Catal. Commun., vol. 43, pp. 66-71, 2014.
[27] Z. A. Alothman, “A review: Fundamental aspects of silicate mesoporous materials,” Materials (Basel)., vol. 5, no. 12, pp. 2874-2902, 2012.
[28] V. V. Kutarov, Y. I. Tarasevich, E. V. Aksenenko, and Z. G. Ivanova, “Adsorption hysteresis for a slit-like pore model,” Russ. J. Phys. Chem. A, vol. 85, no. 7, pp. 1222-1227, 2011.
[29] S. Furmaniak et al., “Water at curved carbon surface: Mechanisms of adsorption revealed by first calorimetric study,” J. Phys. Chem. C, vol. 119, no. 5, pp. 2703-2715, 2015.
[30] R. Ludwig, “Water: From Clusters to the Bulk,” Angew. Chemie Int. Ed., vol. 40, no. 10, pp. 1808-1827, 2001.
[31] H. Yang, SuKim et al., “Water harvesting from air with metal-organic framework powered by natural sunlight,” Science, vol. 434, no. April, pp. 430-434, 2017.
[32] H. Furukawa et al., “Water adsorption in porous metal-organic frameworks and related materials,” J. Am. Chem. Soc., vol. 136, no. 11, pp. 4369-4381, 2014.
[33] I. Majchrzak-Kuceba and D. Bukalak-Gaik, “Regeneration performance of metal-organic frameworks: TG-Vacuum tests,” Journal of Thermal Analysis and calorimetry, vol. 125, no. 3. pp. 1461-1466,2016.
[34] P. L. Llewellyn, F. Schüth, Y. Grillet, F. Rouquerol, J. Rouquerol, and K. K. Unger, “Water Sorption on Mesoporous Aluminosilicate MCM-41,” Langmuir, vol. 11, no. 2, pp. 574-577,1995.
[35] M. V. Solovyeva, L. G. Gordeeva, T. A. Krieger, and Y. I. Aristov, “MOF-801 as a promising material for adsorption cooling: Equilibrium and dynamics of water adsorption,” Energy Conyers. Manag., vol. 174, no. May, pp. 356-363, 2018.
[36] D. Fröhlich et al., “Water adsorption behaviour of CAU-10-H: A thorough investigation of its structure-property relationships,” J. Mater. Chem. A, vol. 4, no. 30, pp. 11859-11869,2016.
[37] H. Reinsch, B. Marszalek, J. Wack, J. Senker, B. Gil, and N. Stock, “A new Al-MOF based on a unique column-shaped inorganic building unit exhibiting strongly hydrophilic sorption behaviour,” Chem. Commun., vol. 48, no. 76, pp. 9486-9488,2012.
[38] Ş. Q̧. Sayilgan, M. Mobedi, and S. Olki.i, “Effect of regeneration temperature on adsorption equilibria and mass diffusivity of zeolite 13x-water pair,” Microporous Mesoporous Mater., vol. 224, pp. 9-16,2016.
[39] J. B. Decoste, G. W. Peterson, B. J. Schindler, K. L. Killops, M. A. Browe, and J. J. Mahle, “The effect of water adsorption on the structure of the carboxylate containing metal-organic frameworks Cu-BTC, Mg-MOF-74, and UiO-66,” J. Mater. Chem. A, vol. 1, no. 38, pp. 11922-11932,2013.
[40] N. Hanikel et al., “Rapid Cycling and Exceptional Yield in a Metal-Organic Framework Water Harvester,” ACS Cent. Sci., vol. 5, no. 10, pp. 1699-1706,2019.
[41] A. LaPotin, H. Kim, S. R. Rao, and E. N. Wang, “Adsorption-Based Atmospheric Water Harvesting: Impact of Material and Component Properties on System-Level Performance,” Acc. Chem. Res., vol. 52, no. 6, pp. 1588-1597, 2019.
[42] “Resorcinol Market.” https://www.grandviewresearch.com/industry-analysis/resorcinol-market.
[43] “Formaldehyde Market.” https://www.pharmacompass.com/price/formaldehyde.
[44] “Nanoshel LLC.” https://www.nanoshel.com/.
[45] M. Rubio-Martinez, C. Avci-Camur, A. W. Thornton, I. Imaz, D. Maspoch, and M. R. Hill, “New synthetic routes towards MOF production at scale,” Chem. Soc. Rev., vol. 46, no. 11, pp. 3453-3480,2017.
[46] S. Kim, Hyunho, Yang et al., “Water harvesting from air with metal-organic frameworks powered by natural sunlight,” Science, vol. 434, no. April, pp. 430-434,2017.
[47] S. Sircar and J. R. Hufton, “Why does the linear driving force model for adsorption kinetics work?,” Adsorption, vol. 6, no. 2, pp. 137-147,2000.
[48] B. Tan, Y. Luo, X. Liang, S. Wang, X. Gao, Z. Zhang, Y. Fang, Mixed-solvothermal synthesis of mil-101(cr) and its water adsorption/desorption performance, Ind. Eng. Chem. Res. 58 (8) (2019) 2983-2990.
[49] N. Ko, P. G. Choi, J. Hong, M. Yeo, S. Sung, K. E. Cordova, H. J. Park, J. K. Yang, J. Kim, Tailoring the water adsorption properties of MIL-101 metal-organic frameworks by partial functionalization, J. Mater. Chem. A 3 (5) (2015) 2057-2064.
[50] H. Kim, et al., Water harvesting from air with metal-organic framework powered by natural sunlight, Science 434 (April) (2017) 430-434.
[51] H. Kim, S. R. Rao, E. A. Kapustin, L. Zhao, S. Yang, O. M. Yaghi, E. N. Wang, Adsorption-based atmospheric water harvesting device for arid climates, Nat. Commun. 9 (1) (2018).
[52] R. W. Stineman, A Consistently Well-behaved Method of Interpolation, Creat. Comput. 6 (1980) 54-57.
[53] E. Flores-Andrade, L. A. Pascual-Pineda, M. X. Quintanilla-Carvajal, G. F. Gutierrez-Lopez, C. I. Beristain, E. Azuara, Fractal surface analysis and thermodynamic properties of moisture sorption of calcium-sucrose powders, Dry. Technol. 36 (9) (2018) 1128-1141.
[54] D. F. Othmer, G. G. Brown, Correlating vapor pressure and latent heat data: A new plot, Ind. Eng. Chem. 32 (6) (1940) 841-856.
[55] H. H. Rowley, W. B. Innes, Relationships between the spreading pressure, adsorption, and wetting, J. Phys. Chem. 46 (7) (1942) 694-705.
[56] A. Wexler, Vapor pressure formulation for water in range 0 to 100 C. A revision, J. Res. Natl. Bur. Stand. Sect. A, Phys. Chem. 80A (5 and 6) (1976) 775.
[57] L. A. Pascual-Pineda, E. Flores-Andrade, L. Alamilla-Belt'ran, J. J. Chanona-P'erez, C. I. Beristain, G. F. Guti'errez-L'opez, E. Azuara, Micropores and their relationship with carotenoids stability: a new tool to study preservation of solid foods, Food Bioprocess Technol. 7 (4) (2014) 1160-1170.
[58] L. Acosta-Dominguez, R. Salazar, M. Jim'enez, E. Azuara, Thermodynamic analysis as a useful tool to study the physical properties of sweet-potato starch films reinforced with alginate microparticles, Polym. Compos. 42 (7) (2021) 3380-3390.
[59] F. Garbassi, L. Balducci, P. Chiurlo, L. Deiana, A study of surface modification of silica using XPS, DRIFT and NMR, Appl. Surf. Sci. 84 (2) (1995) 145-151.
[60] T. A. Vu, G. H. Le, C. D. Dao, L. Q. Dang, K. T. Nguyen, P. T. Dang, H. T. K. Tran, Q. T. Duong, T. V. Nguyen, G. D. Lee, Isomorphous substitution of Cr by Fe in MIL-101 framework and its application as a novel heterogeneous photo-fenton catalyst for reactive dye degradation, RSC Adv. 4 (78) (2014) 41185-41194.
[61] E. F. Vansant P. Van Der Voort K. C. Vrancken Chapter 3 The surface chemistry of silica in Studies in Surface Science and Catalysis 1995 59 77.
[62] A.A. Christy, P.K. Egeberg, Quantitative determination of surface silanol groups in silicagel by deuterium exchange combined with infrared spectroscopy and chemometrics, Analyst 130 (5) (2005) 738-744.
[63] Y. Yang, T. Y. Gan, X. Tan, Spatiotemporal changes of drought characteristics and their dynamic drivers in Canada, Atmos. Res. 232 (August) (2020) 104695.
[64] L. Liu, S. Tan, T. Horikawa, D. D. Do, D. Nicholson, J. Liu, Water adsorption on carbon-A review, Adv. Colloid Interface Sci. 250 (2017) 64-78.
[65] A. Chakraborty, B. B. Saha, S. Koyama, K. C. Ng, K. Srinivasan, Adsorption thermodynamics of silica gel-water systems, J. Chem. Eng. Data 54 (2) (2009) 448-452.
[66] K. C. Ng, H. T. Chua, C. V. Chung, C. H. Loke, T. Kashiwagi, A. Akisawa, B. B. Saha, Experimental investigation of the silica gel-water adsorption isotherm characteristics, Appl. Therm. Eng. 21 (16) (2001) 1631-1642.
[67] H. T. Chua, K. C. Ng, A. Chakraborty, N. M. Oo, M. A. Othman, Adsorption characteristics of silica gel +water systems, J. Chem. Eng. Data 47 (5) (2002) 1177-1181.
[68] H. Kim, H. J. Cho, S. Narayanan, S. Yang, H. Furukawa, S. Schiffres, X. Li, Y.-B. Zhang, J. Jiang, O. M. Yaghi, E. N. Wang, Characterization of adsorption enthalpy of novel water-stable zeolites and metal-organic frameworks, Sci. Rep. 6 (1) (2016).
[68] E. T. Jaynes, Gibbs vs boltzmann entropies, Am. J. Phys. 33 (5) (1965) 391-398.
[71] D. I. Wu, X. Guo, H. Sun, A. Navrotsky, Interplay of confinement and surface energetics in the interaction of water with a metal-organic framework, J. Phys. Chem. C 120 (14) (2016) 7562-7567.
[71] T. Hrdinka, O. Novichr, E. Hanslik, M. Rieder, Possible impacts of floods and droughts on water quality, J. Hydro-Environment Res. 6 (2) (2012) 145-150.
[72] A. LaPotin, Y. Zhong, L. Zhang, L. Zhao, A. Leroy, H. Kim, S. R. Rao, E. N. Wang, Dual-stage atmospheric water harvesting device for scalable solar-driven water production, Joule 5 (1) (2021) 166-182

1. A nanoporous carbonaceous material comprising an elemental content, in wt % based on total weight of the material, in carbon of about 85% to about 99.5%, oxygen of about 0.5% to about 10%, and nitrogen of about 0% to about 5%, and wherein the material is optionally functionalized.

2. A nanoporous carbonaceous material for use in water adsorption, the material comprising an elemental content, in wt % based on total weight of the material, in carbon of about 85% to about 99.5%, oxygen of about 0.5% to about 10%, and nitrogen of about 0% to about 5%, and wherein the material is optionally functionalized.

3. A nanoporous carbonaceous material comprising at least one pyrolyzed organic compound-formaldehyde resin, wherein the organic compound is selected from resorcinol, urea, melamine, a tannin and combinations thereof and wherein the material is optionally functionalized.

4. (canceled)

5. The nanoporous carbonaceous material of a claim 1, wherein the nanoporous carbonaceous material has an average pore size of about 1 to about 10 nm.

6. (canceled)

7. The nanoporous carbonaceous material of claim 1, wherein the nanoporous carbonaceous material has a pore size distribution is about 1.3 to about 1.9 nm.

8. The nanoporous carbonaceous material of claim 1, wherein the nanoporous carbonaceous material has a specific surface area of about 300 m2/g to about 550 m2/g.

9. (canceled)

10. The nanoporous carbonaceous material of claim 1, wherein the nanoporous carbonaceous material has an average pore volume of about 0.20 cm3/g to about 0.50 cm3/g.

11. The nanoporous carbonaceous material of claim 10, wherein the average pore volume is about 0.23 cm3/g to about 0.35 cm3/g.

12. . The nanoporous carbonaceous material of claim 1, wherein the nanoporous carbonaceous material is functionalized with at least one metal or at least one functional group selected from hydroxyl, carbonyl, carboxyl, amino, sulfhydryl, and phosphate groups.

13. The nanoporous carbonaceous material of claim 1, wherein the nanoporous carbonaceous material is functionalized with at least one of nitrogen-based moieties, oxygen-based moieties, sulfur-based moieties, phosphor-based moieties, metal-based moieties or mixtures thereof.

14. The nanoporous carbonaceous material of claim 13, or wherein the at least one of nitrogen-based moieties, oxygen-based moieties, sulfur-based moieties, phosphor-based moieties, metal-based moieties or mixtures thereof are added prior and/or after pyrolysis in an amount from about 10% to about 50% (wt) based on total material.

15. (canceled)

16. The nanoporous carbonaceous material of claim 13, wherein the nitrogen-based moieties is from a heterocyclic organic compound selected from phenathroline, pyridine, pyrrolidine, and pyrrole.

17. The nanoporous carbonaceous material of claim 13, wherein the oxygen-based moieties is from air, pure oxygen, hydrogen peroxide, ozone, carbon dioxide, carbon monoxide or a mixture of O₂/N₂.

18. The nanoporous carbonaceous material of claim 1, wherein the nanoporous carbonaceous material is selected from a nitrogen functionalized material, an oxygen functionalized material, or a nitrogen-oxygen functionalized material.

19. The nanoporous carbonaceous material of claim 1, wherein the nanoporous carbonaceous material has an elemental content, in wt % based on total weight of the material, in carbon of about 86% to about 99%, oxygen of about 0.8% to about 9.5%, and nitrogen of about 0% to about 4.5%.

20-25. (canceled)

26. The nanoporous carbonaceous material of claim 18, wherein the oxygen functionalized material has a surface concentration, in wt % based on total weight of the material, in carbon of about 92% to about 94%, oxygen of about 6% to about 8% and nitrogen of about 0% to about 0.5%.

27. The nanoporous carbonaceous material of claim 18, wherein the nitrogen-oxygen functionalized material has a surface concentration, in wt % based on total weight of the material, in carbon of about 87% to about 89%, oxygen of about 6% to about 8% and nitrogen of about 3% to about 5%.

28. The nanoporous carbonaceous material of claim 1, wherein the nanoporous carbonaceous material has a water adsorption uptake of about 0.1 kgwater/kgmaterial to about 0.2 kgwater/kgmaterial at 40% of relative humidity.

29. The nanoporous carbonaceous material of claim 1, wherein the nanoporous carbonaceous material has a water adsorption uptake of about 0.1 kgwater/kgmaterial to about 0.3 kgwater/kgmaterial at 90% of relative humidity.

30. The nanoporous carbonaceous material of claim 1, wherein the nanoporous carbonaceous material has a water adsorption uptake of about 0.1 kgwater/kgmaterial to about 0.5 kgwater/kgmaterial at 90% of relative humidity.

104. ms 31-104 (Canceled).
